(19) United States
(12) Patent Application Publication
(10) Pub. No.: US 2016/0293143 A1
(43) Pub. Date: Oct. 6, 2016

(54) COMMUNICATION TERMINAL, METHOD OF CONTROLLING COMMUNICATION TERMINAL AND CONTROL PROGRAM

(71) Applicant: SHARP KABUSHIKI KAISHA, Osaka-shi, Osaka (JP)

(72) Inventors: Yuko KANEMOTO, Osaka-shi (JP); Koji KAWADA, Osaka-shi (JP)

(21) Appl. No.: 15/038,112

(22) PCT Filed: Nov. 14, 2014
(86) PCT No.: PCT/JP2014/080240

§ 371 Date: May 20, 2016

(30) Foreign Application Priority Data
Nov. 22, 2013 (JP) 2013-241970
Aug. 8, 2014 (JP) 2014-163079

(51) Int. Cl. G09G 5/38; G06F 3/0346; G06F 3/0484; G06F 1/16

(52) U.S. Cl. CPC G09G 5/38; G06F 1/163; G06F 3/0346; G06F 3/04842; G06F 2200/1614; H04W 4/008

(57) ABSTRACT

It is possible for a user to use a functional portion used while being turned toward an opposite side to a user side or a functional portion used while being turned toward the user with a natural posture, and display is performed in a display direction natural for the user without depending to a putting-on state. A bracelet type communication terminal (200) comprises a first functional portion (120), a second functional portion (130) and a display direction control portion (1121) that controls the display direction on the display portion (12) depending to the putting-on state.

### FIELD OF THE INVENTION

The present invention relates to a communication terminal etc. that performs short distance noncontact wireless communication in a state where a user puts the same on an arm, and comprises a display portion.

### BACKGROUND ART

Conventionally, a communication terminal that can be put on an arm of a person like a wrist watch is known.

In Patent literature 1 cited below, for example, an electronic clock having a noncontact data communication function is disclosed.

Furthermore, in Patent literature 2 cited below, there is disclosed a transceiver that is carried on an arm, and provided with a flexible dielectric base board on a belt that is wound on the arm, and conductive lines are wired on the base board.

### PRIOR ART LITERATURE

### Patent Literature

Patent literature 1: International publication WO2003/023525 (published on Mar. 20, 2003)

Patent literature 2: Japan Utility Model Registration Official Gazette “Jitsu Kai Sho 63-171015 (published on Nov. 8, 1988)”

### SUMMARY OF THE INVENTION

### Problem to be Solved by the Invention

In a communication terminal according to the conventional technology as described above, however, there is a problem that a user is required to take an unnatural form twisting a wrist when trying to perform short distance noncontact data communication with using the communication terminal concerned. In a conventional wrist watch type communication terminal incorporating a noncontact type IC chip such as a FeliCa (registered trademark) chip, for example, an NFC (Near Field Communication: short distance communication) antenna such as a FeliCa (registered trademark) antenna is arranged around a dial plate. That is, in the conventional wrist watch type communication terminal, the above-described NFC antenna is arranged on a back of hand side (or palm side) of the arm (wrist) of the user. Here, a reader/writer that performs short distance noncontact wireless communication such as an electronic money settlement apparatus receives data that is stored in an internal memory of the IC chip such as a FeliCa (registered trademark) chip by supplying electric power to the IC chip concerned by means of electromagnetic induction, and demodulates the data to read information. Furthermore, the above-described reader/writer converts the information into an optimal carrier wave based on a predetermined modulation system, and transmits the information such that the data is written in the internal memory of the above-described IC chip. Therefore, in a case where the user tries to perform an electronic money settlement with using the conventional wrist watch type communication terminal, the user has to bring the back of hand side or the palm side provided with the above-described NFC antenna close to the electronic money settlement apparatus, and accordingly, it is necessary to twist the wrist in the unnatural form. Similarly, in a case where a functional portion such as a camera, light receiving sensor, light, etc. to be used while being turned toward an opposite side to a user side is arranged around the dial plate in a communication terminal that can be put on the arm, when using the functional portion concerned, the wrist must be twisted in the unnatural form. Furthermore, in a case where a functional portion such as a button or microphone that receives an operation by the user, and an LED to press the user attention by blinking etc. that is to be used while being turned toward the user is arranged around the dial plate, the user must twist the wrist in the unnatural form when using the functional portion concerned.

Furthermore, in the wrist watch type communication terminal according to the above-described conventional technology, in a case where a displaying content on a display portion provided on the wrist watch type communication terminal concerned is a time of day by the digital number, for example, if a display direction of the displaying content is turned toward a display direction legible for a user, when putting on a right arm, the displaying content is displayed from a hand side to an elbow side in a longitudinal direction of the right arm, in contrast, when putting on a left arm, the displaying content is displayed from an elbow side to the hand side in a longitudinal direction of the left arm. Therefore, in a case where a switch etc. is provided around the display portion, a position of the switch becomes to be located in the elbow side or the hand side depending on a case where the wrist watch type communication terminal is put on the right arm or a case where it is put on the left arm, and therefore, there is a problem that convenience is bad. Accordingly, in order not to spoil the convenience, it is desirable that the position of the switch etc. is provided around the display portion is unchanged in either a case where the wrist watch type communication terminal is put on the right arm or a case where it is put on the left arm, and that the display direction of the displaying content on the display portion is controlled such that display can be performed in a display direction natural for the user.

The present invention is made in view of the above-described problem, and an object thereof is to provide a communication terminal etc. that the user can use a functional portion to be used while being turned toward an opposite side to a user side or a functional portion to be used while being turned toward the user in a natural posture and that the display can be performed in a display direction natural for the user without depending on whether putting on is a right arm or a left arm and whether the display portion of own communication terminal etc. exists in an inside or outside of the arm of the user when putting on.

### Means for Solving the Problem

In order to solve the above-described problem, a communication terminal according to a form of the present invention is a communication terminal comprising a display portion characterized in that a first functional portion to be used in a state where a user puts the communication terminal on an arm while being turned toward an opposite side to a user side is arranged or the first functional portion concerned is arrangeable, and the communication terminal comprises a display direction control portion configured to control a display direction of a displaying content on the display portion according to whether the communication terminal is put on is a right arm or left arm of a user and whether the display portion exists in an inside or outside of the arm when putting the communication terminal on the arm.

Furthermore, a communication terminal according to a form of the present invention is a communication terminal comprising a display portion characterized in that a second functional portion to be used in a state where a user puts the communication terminal on an arm while being turned toward a user is arranged or the second functional portion concerned is arrangeable, and that the communication terminal comprises a display direction control portion configured to control a display direction of a displaying content on the display portion according to whether the communication terminal is put on is a right arm or left arm of a user and whether the display portion exists in an inside or outside of the arm when putting the communication terminal on the arm.

A control method of a communication terminal according to one embodying form of the present invention is a control method of a communication terminal comprising a display portion characterized in that the above-described communication terminal is arranged with a first functional portion to be used in a state where a user puts the communication terminal on an arm while being turned toward an opposite side to a user side is arranged or arrangeable with the first functional portion concerned, and the method includes a display direction control step configured to control a display direction of a displaying content on the display portion according to whether the communication terminal is put on is a right arm or left arm of a user and whether the display portion exists in an inside or outside of the arm when putting the communication terminal on the arm.

A control method of a communication terminal according to one embodying form of the present invention is a control method of a communication terminal comprising a display portion characterized in that the above-described communication terminal is arranged with a second functional portion to be used in a state where a user puts the communication terminal on an arm while being turned toward a user or arrangeable with the second functional portion concerned, and the method includes a display direction control step configured to control a display direction of a displaying content on the display portion according to whether the communication terminal is put on is a right arm or left arm of a user and whether the display portion exists in an inside or outside of the arm when putting the communication terminal on the arm.

### Advantage of the Invention

According to the above-described structure, it is expectable in the above-described communication terminal an advantage that a functional portion to be used while being turned toward the opposite side to the user side or a functional portion to be used while being turned toward the user can be used by the user in a natural posture and that the display can be performed in a natural display direction without depending on whether the communication terminal is put on the right arm or the left arm and whether the display portion of the above-described communication terminal exists in the inside or outside when putting on.

### BRIEF DESCRIPTION OF THE DRAWINGS

FIG. 1 is a block diagram showing an example of essential structure of a bracelet type communication terminal according to one embodying form of the present invention.

FIG. 2 is a view showing appearances of the terminal of FIG. 1 in cases where the terminal is put on a left arm and a right arm, respectively.

FIG. 3 is a view showing a state where an electronic settlement is performed while putting the terminal of FIG. 1 on the left arm.

FIG. 4 is an explanatory diagram showing an outline of the structure in a cross-section cutting the terminal that is put on the left arm of FIG. 2 along a direction from a palm side to a back of hand side.

FIG. 5 is an explanatory diagram showing the terminal that is put on the left arm of FIG. 2 in a state where the terminal is virtually extended in a longitudinal direction of a belt of the terminal concerned.

FIG. 6 is a view showing an arrangement of an antenna wire for an NFC antenna of the terminal of FIG. 1.

FIG. 7 is a flowchart showing a procedure of processing in the terminal of FIG. 1.

FIG. 8 is a view showing a modified example of a method of arranging an input portion for the terminal of FIG. 1.

FIG. 9 is a block diagram showing an example of essential structure of a bracelet type communication terminal according to a further embodying form of the present invention.

FIG. 10 is a block diagram showing an example of essential structure of a bracelet type communication terminal according to a still further embodying form of the present invention.

FIG. 11 is a block diagram showing an example of essential structure of the bracelet type communication terminal according to a yet further embodying form of the present invention.

FIG. 12 is a view showing an outline of an electronic money settlement system comprising the terminal shown in FIG. 11.

FIG. 13 is a flowchart showing a procedure of processing of a smartphone in the electronic money settlement system of FIG. 12.

FIG. 14 is a block diagram showing an example of essential structure of a bracelet type communication terminal according to a yet still further embodying form of the present invention.

FIG. 15 is an explanatory diagram showing an outline of the structure in a cross-section cutting the terminal shown in FIG. 14 in a state where the terminal is put on a left arm along a direction from a palm side to a back of hand side.

### FORMS FOR EMBODYING THE INVENTION

### Embodying form 1

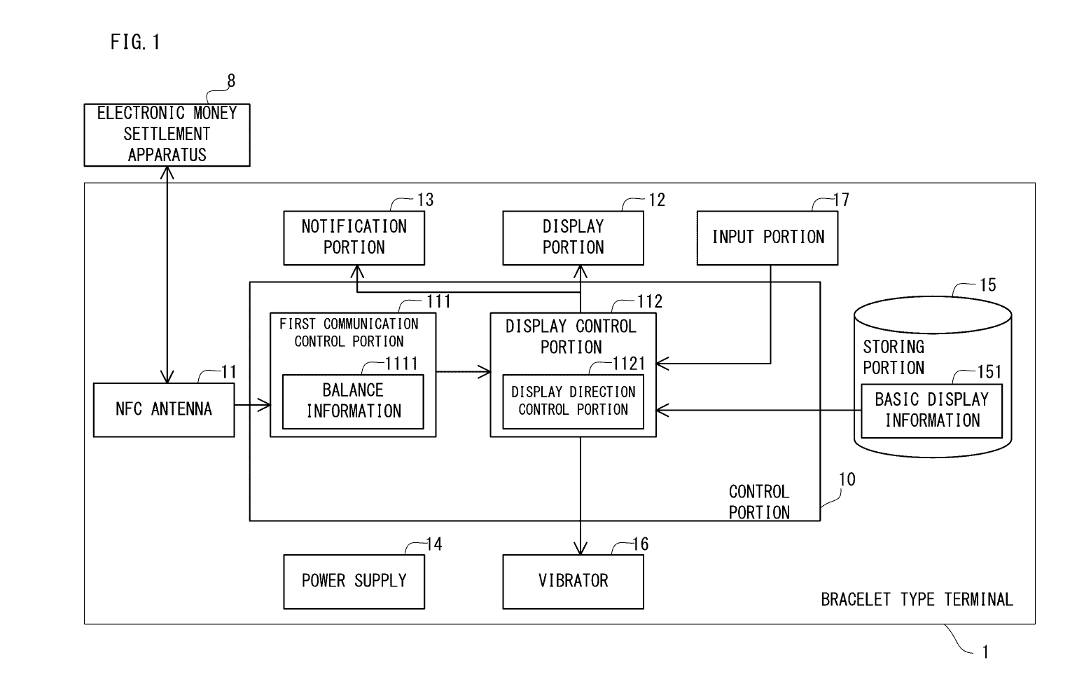

In the following, one embodying form according to the present invention will be described based on FIG. 1 to FIG. 8. Here, a communication terminal according to the embodying form of the present invention will be described for an example that is implemented as a bracelet type communication terminal 1 (hereinafter, simply referred as terminal 1). Furthermore, a user is able to effect payment with electronic money by bringing the terminal 1 close to an electronic money settlement apparatus 8 that comprises a reader/writer. However, an apparatus capable of performing short distance noncontact wireless communication with the terminal 1 is not limited to the electronic money settlement apparatus 8, and may be an apparatus that just has a short distance noncontact wireless communication function. In addition, in the following description, an example that a user puts the terminal 1 on a wrist will be described mainly. That is, about portions that refer to “a little finger side (ulna side)” or “a thumb side (radius side)” in the following description, a case where the user puts the terminal 1 on the wrist is assumed. However, the user may put the terminal 1 on a forearm other than the wrist, and further on an upper arm. That is, the user can put the terminal 1 on an arbitrary position of the arm. The above-described “little finger side (ulna side)” is to be replaced with “a back side of the upper arm when the arm is taken down along a body (back side)” in a case where the user puts the terminal 1 on the upper arm. Similarly, in a case where the user puts the terminal 1 on the upper arm, the above-described “thumb side (radius side)” is to be replaced with “a front side of the upper arm when the arm is taken down along the body.”

Furthermore, although an example of “horizontally writing” is described about a character string displayed on a display portion 12 in the following description, the character string displayed on the display portion 12 may be “vertically writing.” Furthermore, the terminal 1 is particularly effective in a case where the character string displayed on the display portion 12 is written in a plurality of lines.

### (Outline of the Terminal)

It will be as follows if the outline of the terminal 1 is described first. More specifically, the terminal 1 is a communication terminal comprising a display portion 12, wherein an NFC (Near Field Communication: short distance communication) antenna 11 (first antenna) for performing short distance noncontact communication in a state where the user puts the terminal 1 on the arm in the ulna side of the arm in a state where the user puts the communication terminal on the arm is arranged, and the terminal 1 comprises a display direction control portion 1121 that controls a display direction of a displaying content on the display portion 12 according to whether the terminal 1 is put on is a right arm or left arm of the user and whether the display portion 12 exists in an inside or an outside when putting the terminal 1 on the arm. That is, the display direction control portion 1121 changes the display direction of the displaying content on the display portion 12 according to whether the terminal 1 is put on is the right arm or the left arm and whether the display portion 12 exists in the inside (palm side) or the outside (back of hand side) when putting the terminal 1 on the arm. Accordingly, since the display direction of the displaying content on the display portion 12 is changed such that the NFC antenna 11 can be always located in the ulna side of the arm, the user can perform short distance noncontact wireless communication with a natural posture, and the display can be performed on the display portion 12 in a display direction natural for the user. Furthermore, since the user becomes able to perform short distance noncontact wireless communication for payment with the electronic money, for example by using the terminal 1 being wearable, it becomes unnecessary for the user to carry other things such as an electronic settlement card for short distance noncontact wireless communication. Furthermore, since an action for taking the electronic settlement card etc. out of a bag becomes unnecessary, the user can finish payment more speedily. Details will be described below.

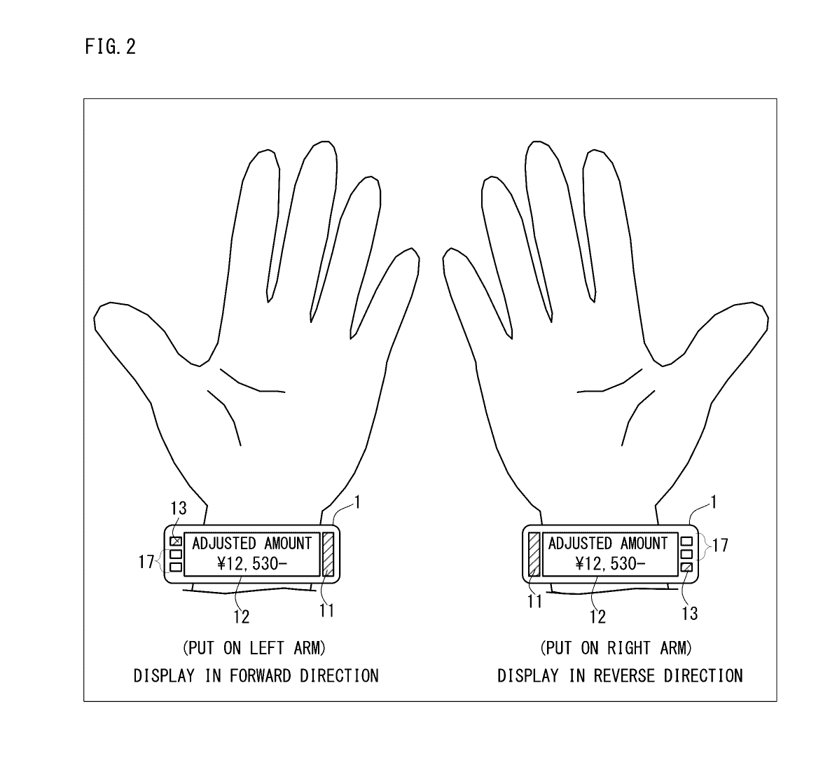

FIG. 2 is a view showing appearances of the terminal 1 in cases where the terminal 1 is put on a left arm and a right arm, respectively. In addition, in the following, in a case where the terminal 1 is put on the left arm (left wrist) such that the display portion 12 comes to an inside of the arm (palm side), a display direction of the content displayed on the display portion 12 is called “forward direction.” Furthermore, in a case where the terminal 1 is put on the right arm (right wrist) such that the display portion 12 comes to an inside of the arm (palm side), a display direction of the content displayed on the display portion 12 is called “reverse direction.” The display direction control portion 1121 reverses vertically and horizontally the display direction of the content displayed on the display portion 12 according to whether the terminal 1 is put on the right arm or the left arm and whether the display portion 12 exists in the inside (palm side) or the outside (back of hand side) of the arm when putting on the terminal 1. That is, the display direction control portion 1121 displays the displaying content on the display portion 12 in the “forward direction” in a case where the terminal 1 is put on the left arm such that the display portion 12 comes to the inside of the arm concerned or in a case where the terminal 1 is put on the right arm such that the display portion 12 comes to the outside (back of hand side) of the arm concerned. On the other hand, the display direction control portion 1121 displays the displaying content on the display portion 12 in the “reverse direction” in a case where the terminal 1 is put on the left arm such that the display portion 12 comes to the outside of the arm concerned or in a case where the terminal 1 is put on the right arm such that the inside of the arm concerned.

Accordingly, even if the terminal 1 is put on either the right arm and the left arm and even if the display portion 12 exists in either the inside and the outside of the arm when being attached, the NFC antenna 11 is located in the ulna side of the arm of the user and the displaying content on the display portion 12 is not reversed vertically and horizontally viewed from the user. That is, the display direction control portion 1121 controls the display direction on the display portion 12 according to whether putting on is the right arm or the left arm and the display portion 12 is located in the inside or the outside when putting on the terminal 1. Accordingly, it is possible for the user to put on the terminal 1 such that the NFC antenna 11 is always located in the ulna side of the arm when putting the terminal 1 on either the right arm and the left arm, and the display direction of the content displayed on the display portion 12 is not changed when viewed from the user. Since the NFC antenna 11 is arranged such that the NFC antenna 11 is always located in the little finger side (ulna side) when putting on the terminal 1, the user easily makes the NFC antenna 11 of the terminal 1 touch the electronic money settlement apparatus 8 with a natural action at the time of settlement. Furthermore, even if the terminal 1 is changed to be put on one of the right wrist and the left wrist to the other, the display direction on the display portion 12 is always controlled by the display direction control portion 1121 so as to begin from the upper left and terminate at the lower right viewed from the user. Accordingly, the user can easily grasp the displaying content displayed on the display portion 12.

The display portion 12 of the terminal 1 is arranged to be located in the inside of the arm, i.e., the palm side of the arm when putting the terminal 1 on the arm concerned. Furthermore, as for a shape of the display portion 12, a length of the display portion 12 in a direction perpendicular to a direction going around the arm may be arbitrary as long as the terminal 1 does not overlap with a joint of the wrist of the user when putting on the terminal 1 and thus it does not become for the user difficult to bend the wrist. The display portion 12 may be a shape elongated in the above-described direction going around the arm, for example. By arranging the display portion 12 to be located in the inside of the arm (wrist), it becomes difficult for a person except the user to see the content displayed on the display portion 12. Especially, in a case where information such as billing information etc. that is acquired from a first communication control portion 111 etc. is displayed on the display portion 12, it is assumed that the user wishes the content displayed on the display portion 12 is not looked in by a person other than the user. In the terminal 1, since the display portion 12 is arranged to be located in the inside of the wrist, it becomes easy for the user to prevent the displaying content such as billing information etc. displayed on the display portion 12 from being looked by a person except the user. In addition, information such as a time of day etc., for example that is not related with the first communication control portion 111 may be displayed on the display portion 12. The content displayed on the display portion 12 will be described later in detail. Furthermore, in general, if the display portion 12 that displays various kinds of information is located in the inside of the arm (wrist), the user is easy to have a sense of security psychologically.

Furthermore, since the display portion 12 is arranged to be located in the inside of the arm (wrist) that the terminal 1 is put on, the display portion 12 can have a large area in comparison with a case where it is arranged in the ulna side or the radius side of the arm concerned. Especially, by making the display portion 12 be in a shape that is long in a surrounding direction of the arm (wrist) and short in a direction perpendicular to the surrounding direction of the arm, it is possible to secure an area of the display portion 12 large in comparison with a case where it is made to be in a shape that is short in the surrounding direction of the arm (wrist) and long in a direction perpendicular to the surrounding direction of the arm. That is, by making the display portion 12 be in a shape that is long in the surrounding direction of the arm (wrist), an area of the display portion 12 is secured to be large while avoiding that the display portion 12 becomes a hindrance when the user bends or lengthens the wrist. Since the area of the display portion 12 is secured to be large, the terminal 1 can display information such as billing information on the electronic money settlement, balance information 1111, ID information of the first communication control portion 111, a time of day, etc. on the display portion 12 in detail, for example. The content displayed on the display portion 12 will be described later in detail. Furthermore, since the display portion 12 has a shape elongated in the direction going around the arm of the user, the display portion 12 does not become a hindrance when the user bends or lengthens the wrist.

In addition, in a case where the display portion 12 has a shape elongated in the direction going around the arm, especially, the control of the display direction of the displaying content displayed on the display portion 12 by the display direction control portion 1121 becomes important. In a case where a shape of the display portion 12 is circular, and therefore, the user can easily recognize the displaying content even if the display direction is vertically and horizontally reversed, for example, the necessity of reversing the display direction according to whether the terminal 1 is put on is the left arm or the right arm and whether the display portion 12 comes to the inside or the outside of the arm when putting on it is low. However, as shown in FIG. 2, various kinds of information such as amount of money paid in the settlement of electronic money, the balance information 1111, ID information on the first communication control portion 111 that is a FeliCa (registered trademark) chip, etc., are displayed on the display portion 12. If the display direction is vertically and horizontally reversed, the user cannot easily recognize the displaying content of these pieces of information displayed on the display portion 12. Particularly, as described above, the display portion 12 is arranged so as to secure a predetermined area by making it in a shape elongated in the surrounding direction of the arm, and displays the amount paid, the balance information 1111, the ID information on the first communication control portion 111, the time of day, etc. in detail. Accordingly, if the display direction of the displaying content displayed on the display portion 12 is vertically and horizontally reversed, it becomes difficult for the user to recognize the displaying content. In order to solve this problem, in the terminal 1, the display direction control portion 1121 controls the display direction on the display portion 12 according to whether the terminal 1 is put on is the left arm or the right arm and whether the display portion 12 is located in the inside or the outside of the arm when putting on it. Accordingly, it becomes possible for the user to make the NFC antenna 11 always locate in the little finger side (ulna side), and to put the terminal 1 on either the left and right arm, and to confirm the above-described various kinds of information displayed on the display portion 12 in detail with a display direction natural for the user.

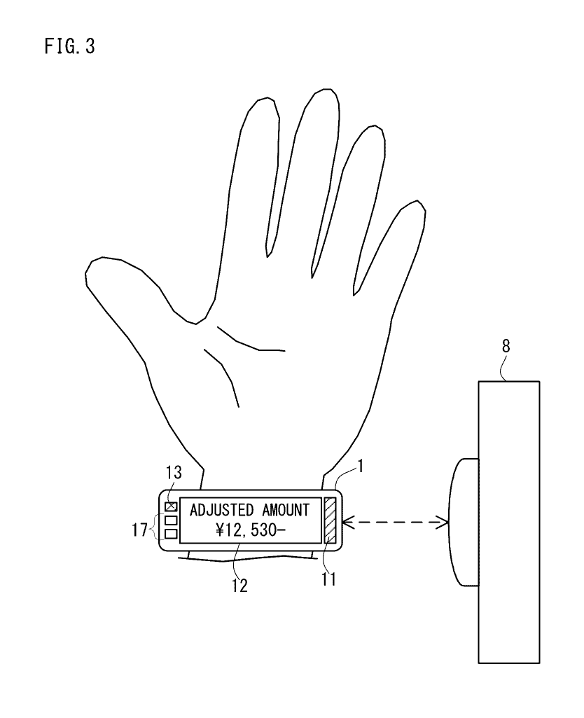

FIG. 3 is a view showing a state where the terminal 1 is put on the left arm to perform electronic settlement. In FIG. 3, it is shown a state where the terminal 1 is put on the left arm such that the display portion 12 comes to the inside of the arm, and the electronic settlement is performed by bringing the terminal 1 close to the electronic money settlement apparatus 8. As shown in FIG. 3, the user does not need to twist the wrist unnaturally at the time of the payment with the electronic money by using the terminal 1 that the NFC antenna 11 is arranged to be located in the little finger side (ulna side) of the arm (wrist) when putting on it. That is, by using the terminal 1, the user can make the payment with the electronic money by bringing the terminal 1 close to the electronic money settlement apparatus 8 in a natural touch action without twisting the wrist.

In contrast, in a case where the user tries to perform short distance noncontact communication such as an electronic settlement with using a conventional wearable communication terminal that the FeliCa (registered trademark) antenna etc. is arranged in the back of hand side or the palm side of the wrist, the user must twist the wrist unnaturally. In the conventional electronic money system, for example, an electronic settlement card that is mounted with a noncontact IC chip such as a FeliCa (registered trademark) chip is common, and there are few communication terminals each having a wearable shape that is always put on and an electronic money function. The above-described electronic settlement card must be carried with being put into a wallet when going out, and, on the other hand, as for the conventional wearable communication terminal having the electronic money function, there is a problem that the user has to perform an unnatural action twisting the wrist at the time of settlement. Specifically, the conventional wearable communication terminal is of a shape such as a wrist watch, and an antenna for noncontact IC chip such as a FeliCa (registered trademark) chip having the electronic money function is arranged around a time display portion (dial portion). That is, in the conventional wearable communication terminal, an antenna for short distance noncontact wireless communication such as a FeliCa (registered trademark) antenna is arranged in the back of hand side or the palm side of the wrist. Therefore, when effecting payment using the conventional wearable communication terminal, the user must bring the back of hand side or the palm side of the wrist that the antenna for short distance noncontact wireless communication of the terminal is arranged close to a data reading/writing portion of an external electronic money settlement apparatus. Accordingly, the user has to take an unnatural posture at the time of settlement, and may have hurt the wrist.

In the terminal 1, the NFC antenna 11 is arranged to be located in the little finger side (ulna side) of the wrist of the user, and the display portion 12 is arranged to be located in the inside of the wrist (palm side). Furthermore, the display direction control portion 1121 controls the display direction of the displaying content on the display portion 12 according to whether the terminal 1 is put on the left or right arm. Accordingly, the user can put the terminal 1 on either the left arm and the right arm such that the display direction of the character etc. displayed on the display portion 12 is not vertically and horizontally reversed when viewed from the user and the NFC antenna 11 may always be located in the ulna side. Since the NFC antenna 11 always comes to the ulna side of the wrist of the user, the user does not need to take an unnatural posture such as twisting a wrist at the time of settlement.

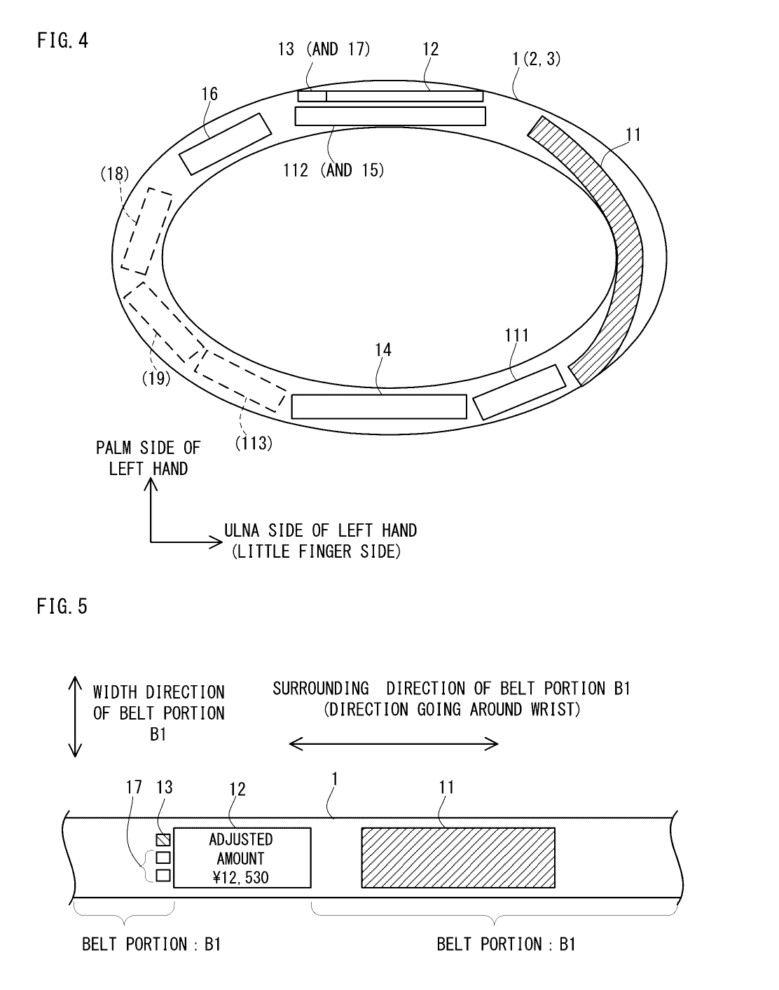

FIG. 4 is an explanatory diagram showing an outline of structure in a cross-section cutting the terminal 1 that is put on the left arm in FIG. 2 along a direction to the back of hand side from the palm side. As shown in FIG. 4, the terminal 1 further comprises an input portion 17 that selects whether the terminal 1 is put on is the right arm or the left arm of the user and whether the display portion 12 exists in the inside or the outside of the arm when putting the terminal 1 on the arm. Then, the display direction control portion 1121 controls the display direction of the displaying content on the display portion 12 according to a selection result acquired from the input portion 17. That is, if the user operates the input portion 17 and selects whether the terminal 1 is put on the left or right arm and whether the display portion 12 comes to the inside of the arm or the outside of the arm when putting on it, the input portion 17 notifies contents of the selection to the display direction control portion 1121. If the above-described notification is received from the input portion 17, the display direction control portion 1121 controls the display direction of the displaying content on the display portion 12 based on whether the terminal 1 is put on the left or right arm and whether the display portion 12 exists in the inside or outside of the arm when putting on the terminal 1. That is, the display direction control portion 1121 controls the display direction of the displaying content of the display portion 12 based on a putting-on state by the user acquired via the input portion 17. Accordingly, if it is input to the input portion 17 whether the terminal 1 is put on the left or right arm and whether the display portion 12 is located in the inside or the outside of the arm, the terminal 1 can make the display portion 12 perform display in a display direction natural for the user without depending on the putting-on state of the terminal 1. Furthermore, since the display direction control portion 1121 controls the display direction of the displaying content on the display portion 12 based on the putting-on state that is input to the input portion 17 such that the display can be naturally viewed from the user, the user can put on the terminal 1 such that the NFC antenna 11 is always located in the ulna side of the arm. Accordingly, the user can perform short distance noncontact wireless communication with a natural posture by using the terminal 1 without depending on whether the terminal 1 is put on the left or right arm and whether the terminal 1 is put on such that the display portion 12 comes to the inside of the arm or the outside of the arm.

Furthermore, as shown in FIG. 4, in the terminal 1, the NFC antenna 11 is located in the ulna side (little finger side) of the left arm that terminal 1 intends to be put on, the input portion 17 is located in the radius side (thumb side), and the display portion 12 is located in the inside of the left arm (palm side). Hare, the display direction control portion 1121 controls the display direction of the displaying content on the display portion 12 according to whether the terminal 1 is put on the left or the right arm (wrist). Therefore, the user can put the terminal 1 on either the left and right arm such that the displaying content on the display portion 12 is not vertically and horizontally reversed when viewed from the user and the input portion 17 is always located in the radius side of the wrist of the user. Since the input portion 17 always exists in the thumb side of the wrist of the user, it is easy for the user to operate the input portion 17 by a hand contrary to a hand that the terminal 1 is put on. That is, it is not necessary to perform an unnatural action of, for example, turning the palm downward, or turning the arm (wrist) upside down when trying to perform an action that operates the input portion 17 while bringing the little finger side of the hand close to the electronic money settlement apparatus 8. That is, it is possible to operate the input portion 17 by a hand contrary to a hand that the terminal 1 is put on without twisting the wrist since the input portion 17 is located in the thumb side of the wrist even if it is in the midst of performing an action that holds the ulna side of the wrist or the palm up over something

FIG. 5 is an explanatory diagram showing the terminal 1 that is put on the left arm of FIG. 2 in a state virtually extended in a longitudinal direction of a belt of the terminal 1. The NFC antenna 11 is in a shape that is elongate in a longitudinal direction of the belt B1, i.e., in a direction going around the arm (wrist), that is, in a shape that is long in the direction going around the arm and short in the direction perpendicular to the direction going around the arm. Then, the NFC antenna 11 is arranged to be located in the ulna side of the wrist of the user. Accordingly, even if the NFC antenna 11 is deviated a little from its center in the longitudinal direction of the belt B1, that is, in the direction going around the arm, it is possible to make the NFC antenna 11 and the electronic money settlement apparatus 8 surely perform short distance noncontact wireless communication with each other. In addition thereto, the little finger side (ulna side) of the wrist is, in general, a place that is not visible easily from other people and thus inconspicuous. By arranging the NFC antenna 11 in the small finger side of the wrist being inconspicuous, it is improve a design by making reduce widths of the back of hand side of the wrist and a portion of the palm side that are visible easily from the outside.

Here, in order to normally operate the antenna for a noncontact IC chip, an area that the antenna occupies must be made larger than a predetermined size. Therefore, in the conventional wearable communication terminal having an electronic money function, in order to secure a predetermined area for the antenna for a noncontact IC chip, the antenna for a noncontact IC chip is arranged in a position capable of easily securing the predetermined area in the back of hand side or the palm side etc. of the wrist.

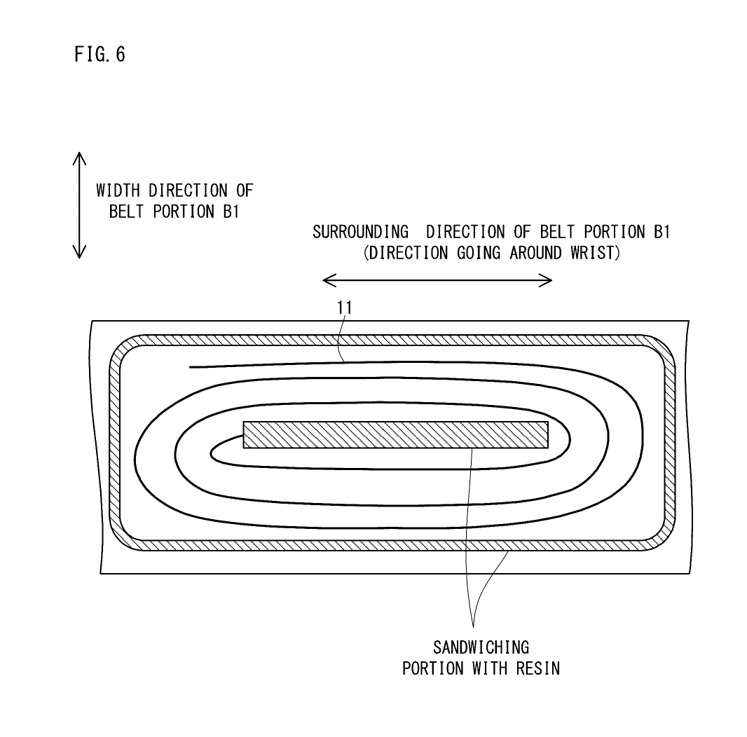

FIG. 6 is a view showing an antenna wire arrangement about the NFC antenna 11 of the terminal 1. In contrast to the above-described conventional wearable communication terminal, in the terminal 1, as shown in FIG. 6, a shape of the NFC antenna 11 is improved to be lengthened in the longitudinal direction of the belt of the terminal 1 (surrounding direction of the wrist) and shortened in the width direction of the belt (direction perpendicular to the direction going around the arm). By such improvement in the terminal 1, it becomes possible to arrange the NFC antenna 11 in a belt portion B1 of the terminal 1. In more detail, about the NFC antenna 11, the antenna wire is spirally arranged so as to form a space in a center portion of the NFC antenna 11, and be elongated horizontally, that is, lengthened in the direction going around the arm, and be shortened in the direction perpendicular to the direction going around the arm. Then, a circumference and the center space portion of the above-described antenna wire, that is, portions drawn with thick black lines in FIG. 6 are respectively stuck with a resin from upper and lower sides. Accordingly, it is devised such that the NFC antenna 11 becomes hard to peel off from a main body of the terminal 1.

Furthermore, in the terminal 1, the NFC antenna 11 for short distance noncontact wireless communication is arranged in the belt portion B1 separated from the display portion 12, and is arranged especially in the following position of the belt portion B1. That is, the NFC antenna 11 is arranged in the belt portion B1 such that the NFC antenna 11 comes to a side surface (ulna side) of the arm (wrist) of the user when putting on the terminal 1. Accordingly, by using the terminal 1, the user can perform short distance noncontact wireless communication with a natural posture and confirm the content displayed on the display portion 12 in a display direction natural for the user without depending on whether the terminal 1 is put on is the right arm or the left arm.

Furthermore, it is preferable in the terminal 1 that the control portion 10 is arranged separately from the NFC antenna 11. By arranging the control portion 10 separately from the NFC antenna 11, the terminal 1 can make its structure thin in comparison with structure that the control portion 10 and the NFC antenna 11 are formed into an integral type.

About the terminal 1 that the outline is described above, in the following, further details will be described.

### (Essential Structure of the Terminal)

FIG. 1 is a block diagram showing an example of the essential structure of the terminal 1. The terminal 1 comprises the control portion 10, the NFC antenna 11 and the display portion 12 as shown in FIG. 1. In addition, the terminal 1 may further comprise a notification portion 13, a power supply 14, a storing portion 15, a vibrator 16 and the input portion 17. However, the notification portion 13, the power supply 14, the storing portion 15, the vibrator 16 and the input portion 17 are not indispensable for following two structures that the terminal 1 has. That is, the notification portion 13, the power supply 14, the storing portion 15, the vibrator 16 and the input portion 17 are not indispensable in the structure that the NFC antenna 11 is arranged such that the NFC antenna 11 is located in the ulna side of the wrist of the user when putting the terminal 1 on the wrist. Furthermore, the above-described components are not directly related to the terminal 1 that the display direction of the displaying content on the display portion 12 is controlled depending on whether the terminal 1 is put on is the left or right arm and whether the display portion 12 exists in the inside or the outside of the arm when putting on the terminal 1. In addition, the terminal 1 may be provided with a short distance wireless antenna 19 for performing short distance wireless communication with an external setting apparatus such as a smartphone 5, and a second communication control portion 113 that controls the short distance wireless communication concerned. Details about the short distance wireless antenna 19 and the second communication control portion 113 will be described later. Furthermore, in order to secure simplicity of description, a part of the structure of not being directly related to this embodying form (a portion that the terminal 1 notifies to the user arrival of telephone/mail to the smartphone 5, etc.) is omitted from the description and the block diagram. However, the terminal 1 may be provided with such omitted structure according to embodying actual circumstances.

The NFC antenna 11 is an antenna for short distance noncontact wireless communication, and is a FeliCa (registered trademark) antenna, for example. The NFC antenna 11 is a communication interface that performs short distance noncontact wireless communication with the electronic money settlement apparatus 8 etc. that is an IC card reader/writer, and can also be said to be a noncontact IC chip wireless communication portion.

The NFC antenna 11 is arranged in the belt portion B1 that is separated from the display portion 12, and further arranged or can be arranged such that the NFC antenna 11 comes to the little finger side (ulna side) of the arm of the user when the user puts on the terminal 1. In the terminal 1, the NFC antenna 11 is provided in a position away from a metal used in components, a base board, etc. included in functional portion (display portion 12 etc., for example) other than NFC antenna 11 of the terminal 1. There is a possibility that a sensitivity of the NFC antenna 11 decreases if a metal is near, and in a case where the sensitivity of the NFC antenna 11 decreases due to the metal existing near the NFC antenna 11, the terminal 1 is desirable to provide with the NFC antenna 11 by separating from the metal used in the functional portions other than the NFC antenna 11 by a suitable distance. In the terminal 1, it is possible to separate the NFC antenna 11 from the metal included in the functional portions other than the NFC antenna 11, such as the display portion 12, by arranging the NFC antenna 11 in the belt portion B1 that is separated from the display portion 12. Accordingly, the terminal 1 can prevent the decrease of the communication function of the NFC antenna 11.

The display portion 12 is a display on the basis of an OLED (Organic Light-Emitting Diode) or an LED (Light-Emitting Diode), for example. The display portion 12 displays the ID information of the first communication control portion 111 etc. at the time of electronic settlement, but may display a time and day to notify the time and day to the user at the time except the settlement. Furthermore, information concerning the communication that the terminal 1 performs etc., for example may be displayed on the display portion 12. Furthermore, although described later in detail, in a case where the terminal 1 can perform communication with an external setting apparatus such as the smartphone 5, the display portion 12 may be able to display information concerning arrival to the smartphone 5 etc. For example, it may be able to display from whom there is arrival of telephone/mail to the smartphone 5. Furthermore, in a case where an electronic money balance, billing information at the time of electronic money settlement, etc. can be acquired from the smartphone 5, these pieces of information may be displayed.

In addition, in the terminal 1 shown in FIG. 1, the balance information of the NFC antenna 11 that is a FeliCa (registered trademark) antenna is stored in an internal memory of the terminal 1 as balance information 1111. Describing more exactly, the balance information 1111 of the first communication control portion 111 (noncontact IC chip comprising an electronic money settlement function) that is a FeliCa (registered trademark) chip, for example is stored in the internal memory of the terminal 1. Therefore, even in a case where the terminal 1 fails to acquire the electronic money balance, the billing information at the time of electronic money settlement, etc. of the user from the smartphone 5, the terminal 1 can acquire the balance information of the NFC antenna 11 from the NFC antenna 11 directly, and can also display it on the display portion 12.

That is, in the terminal 1, the NFC antenna 11 is an antenna of the first communication control portion 111 (noncontact IC chip comprising an electronic money settlement function), and information that is concerned with the electronic money settlement performed between the first communication control portion 111 and the external electronic money settlement apparatus 8, and acquired from the first communication control portion 111 or the electronic money settlement apparatus 8 is displayed on the display portion 12. By displaying the information concerning the electronic settlement such as the billing information at the time of settlement on the display portion 12, the user can confirm the information by looking at the display portion 12. In addition, since power consumption is large, it is desirable that the display portion 12 is turned off automatically after performing the display for a predetermined time period. In addition, turning on/off of the display portion 12 may be switched by the user by operating the input portion 17.

The notification portion 13 visually notifies to the user information concerning the communication that is performed by the terminal 1 by performing operation such as blinking etc. together with the display portion 12 or independently. The notification portion 13 is an LED (Light Emitting Diode), for example. The notification portion 13 blinks white during a time when the short distance noncontact wireless communication with the electronic money settlement apparatus 8 is performed, and blinks green when the communication results in success, and blinks red when the communication results in failure, for example. It becomes possible for the user to easily confirm, by the color of blink of the notification portion 13, that settlement processing by the electronic money, etc. is being performed, whether settlement processing has gone well or wrong, etc. Furthermore, in a case where there is the arrival to the smartphone 5, in order to notify the user of the arrival, the notification portion 13 may blink. By seeing the blink of the notification portion 13, the user can easily notice information concerning the communication etc. that the terminal 1 performs, including a result of the short distance noncontact wireless communication with the electronic money settlement apparatus 8 etc., for example. In addition, it is desirable that the display portion 12 is automatically turned off after the turn on for a predetermined time period, but in contrast, it is desirable that the notification portion 13 continues to blink at a predetermined time interval unless a blink suspension instruction from the user is input. In general, since the notification portion 13 has power consumption smaller than that of the display portion 12, even if continuing the blink at the predetermined time interval, electricity consumption is small. There is an occasion that the user who did not notice blink (notification) by the notification portion 13 at the beginning after the notification portion 13 starts the blink becomes to notice the blink by the notification portion 13 after a while. By continuing the blink at the predetermined time interval, the notification portion 13 can notify, with small power consumption, to the user the information related to the communication that the terminal 1 performs, etc. In addition, the user may stop the blink of the notification portion 13 by operating the input portion 17.

The power supply 14 is a small and lightweight rechargeable battery that does not require frequent replacement. If a power consumption amount of the terminal 1 becomes very small, the power supply 14 may utilize a button dry cell.

The vibrator 16 generates vibration in order to notify the user of the information related to the communication etc. that the terminal 1 performs. The vibrator 16 is implemented by a motor, a drive circuit that drives the motor, etc. Even in a case where the user does not see the display portion 12 and the notification portion 13 while the user is sleeping or working, for example, if the vibrator 16 vibrates, the user becomes easy to notice an operation of the terminals 1 such as communication. In addition, the vibration of the vibrator 16 may be stopped by the user by operating the input portion 17.

The input portion 17 is a predetermined interface for the user to give an input to the terminal 1, and is a tactile switch, for example. The user operates the input portion 17 to input to the terminal 1 selection on whether the terminal 1 is put on the right arm or on the left arm. The user operates the input portion 17 to input to the terminal 1 selection on whether the terminal 1 is put on such that the display portion 12 comes to the inside (palm side) of the arm (wrist) or the terminal 1 is put on such that the display portion 12 comes to the outside (back of hand side) of the arm (wrist). The user may input an instruction of action, etc. to the display, notification, etc. by the display portion 12, the notification portion 13, etc., to the terminal 1 by operating the input portion 17. The user may perform operations such as switching of turning on/off of the terminal 1, stopping of the notification by the display portion 12 and the notification portion 13 etc., display change of the time and day display and other notification contents display on the display portion 12, display on the display portion 12 details of other notification contents, for example. It is desirable for the input portion 17 to be arranged such that it is located in the thumb side (radius side) of the arm (wrist) when the user puts the terminal 1 on the arm. Even when the little finger side (ulna side) of the wrist is being turned toward the external short distance noncontact wireless communication apparatus such as the electronic money settlement apparatus 8 during the settlement etc., the user becomes possible to easily operate the input portion 17 because the input portion 17 is arranged to be located in the thumb side. In addition, the input portion 17 may receive a user operation to switch turning on/off of the power supply of the terminal 1 itself. Furthermore, the display portion 12 and the input portion 17 may be implemented by a touch panel capable of detecting contact to an input screen as an input to the terminal 1. The input portion 17 outputs the above-described input applied by the user to the display control portion 112, and especially outputs the putting-on state of the terminal 1 to the display direction control portion 1121.

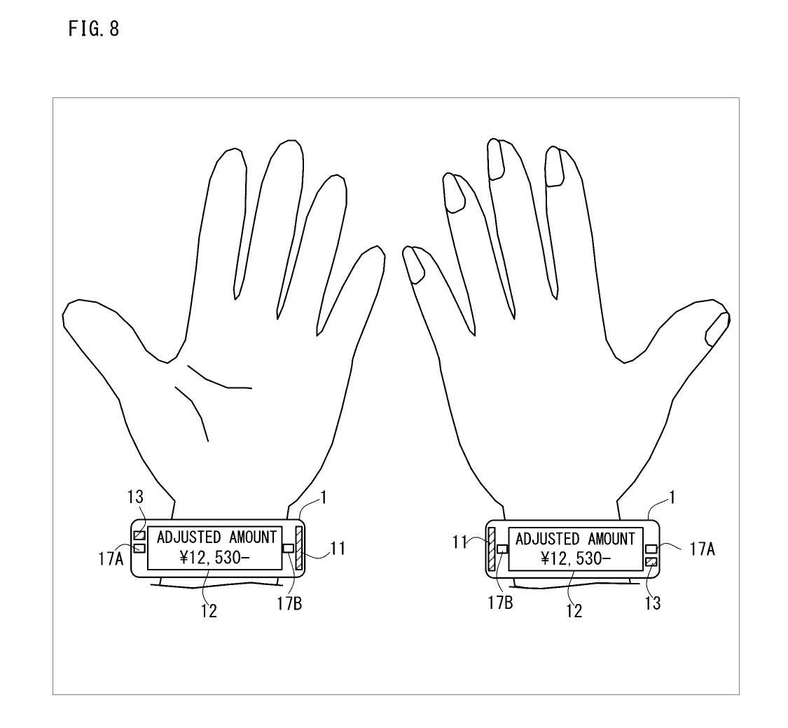

Furthermore, as shown in FIG. 8, in a case where the two input portions 17 are arranged while sandwiching the display portion 12 in the direction going around the arm, that is, in a case where an input portion 17A and an input portion 17B are arranged in the thumb side (radius side) and the little finger side (ulna side) of the display portion 12, respectively, the terminal 1 may perform the following processing. In addition, in the following description, in a case where the display portion 12 exists in the left palm side (or the right back of hand side), it is assumed that the input portion 17 in the thumb side (radius side) is the input portion 17A and the input portion 17 in the little finger side (ulna side) is the input portion 17B. Here, in a case where the display portion 12 exists in the palm side, what it is easy to operate by a hand that the terminal 1 is not put on without interrupting the display on the display portion 12 is the input portion 17B. Furthermore, in a case where the display portion 12 exists in the back of hand side, what it is easy to operate by a hand that the terminal 1 is not put on without interrupting the display on the display portion 12 is the input portion 17A. Therefore, according to whether the display portion 12 exists in the palm side or the back of hand side when putting on the terminal 1, functions of the input portion 17A and the input portion 17B may be changed by the display direction control portion 1121 as follows. That is, according to whether the display portion 12 is located in the palm side or back of hand side when putting on the terminal 1, a function to use frequently, such as stopping notification etc. may be assigned to the one that it is easy to operate among the input portion 17A and the input portion 17B. That is, in a case where it is judged that the terminal 1 is put on such that the display portion 12 comes to the palm side, the terminal 1 assigns the function to use frequently, such as stopping notification etc. to the input portion 17B such that the hand of the user who tries to operate the input portion 17 does not interrupt the display on the display portion 12. On the other hand, in a case where it is judged that the terminal 1 is put on such that the display portion 12 comes to the back of hand side, the terminal 1 assigns the function that is frequently used to the input portion 17A.

As described above, in a case where it is judged that the terminal 1 is put on such that the display portion 12 comes to the palm side, the display direction control portion 1121 of the terminal 1 assigns the function to use frequently, such as stopping notification etc. to the input portion 17B. On the other hand, in a case where it is judged that the terminal 1 is put on such that the display portion 12 comes to the back of hand side, the display direction control portion 1121 of the terminal 1 assigns the function to use frequently, such as stopping notification etc. to the input portion 17A. Therefore, it becomes possible for the user to operate the function to use frequently, such as stopping notification etc. without interrupting the display on the display portion 12 even if the terminal 1 is put on either the right arm and the left arm and even if the terminal 1 is put on such that the display portion 12 comes to either the palm side and the back of hand side.

The storing portion 15 stores various data that the terminal 1 uses. The storing portion 15 stores (1) a control program, (2) an OS program and (3) application programs for performing various kinds of functions that are executed by the control portion 10 of the terminal 1, and (4) various kinds of data that are read when executing the application program. Furthermore, basic display information 151 is stored in the storing portion 15, and details thereof will be described later. Data of the above-described (1)-(4) are stored in a nonvolatile storages such as a ROM (Read Only Memory), a flash memory, an EPROM (Erasable Programmable ROM), an EEPROM (registered trademark) (Electrically EPROM), an HDD (Hard Disc Drive), etc. The terminal 1 may be provided with a temporarily storing portion not shown. The temporarily storing portion is a so-called working memory that temporarily stores data used for calculations, calculation results, etc. in the course of various processing that the terminal 1 performs, and is constituted by a volatile storage such as a RAM (Random Access Memory). About which data is to be stored to which storage, it is suitably decided based on a purpose of using the terminal 1, convenience, cost, physical restrictions, etc.

The control portion 10 controls the functions of the terminal 1 generally. In the control portion 10 illustrated, the first communication control portion 111 and the display control portion 112 are included as functional blocks. Each functional block of the above-described control portion 10 can be implemented by reading the programs stored in the storage (storing portion 15) constituted by a ROM (Read Only Memory), an NVRAM (Non-Volatile Random Access Memory), etc. into the RAM (Random Access Memory) etc. not shown and executing the programs by a CPU (Central Processing Unit) etc. In the following, details will be described.

### (Outline of Each Functional Block)

The first communication control portion 111 performs short distance noncontact wireless communication with an external communication terminal such as the electronic money settlement apparatus 8 via the NFC antenna 11, and it is a FeliCa (registered trademark) chip, for example, and may be said as a noncontact IC chip. In addition, the noncontact chip means an integrated circuit that comprises an inherent number (ID information), a memory and a circuit antenna for transmitting and receiving information stored in the memory, that is, the first communication control portion 111 has inherent ID information. Furthermore, the first communication control portion 111 stores data of the balance information 1111 of the electronic money, etc. in the internal memory. The data stored in the internal memory of first communication control portion 111 is transmitted to the electronic money settlement apparatus 8 via the NFC antenna 11. Furthermore, data transmitted from the electronic money settlement apparatus 8 is received by the first communication control portion 111 via the NFC antenna 11, and is written into the internal memory of first communication control portion 111.

The display control portion 112 controls the display on the display portion 12, etc., and includes the display direction control portion 1121. The display control portion 112 may make the display portion 12 display the ID of the first communication control portion 111 in a case where the user performs the electronic settlement by bringing the NFC antenna 11 close to the electronic money settlement apparatus 8, for example, and may make the display portion 12 display the time and day at the time except the electronic settlement. Furthermore, in a case where the display control portion 112 can acquire the balance information 1111 of the electronic money, the billing information, etc., the display control portion 112 may make the display portion 12 display the balance information 1111, the billing information, etc. Furthermore, in a case where the display control portion 112 can acquire that there is the arrival of telephone/mail to the smartphone 5, the display control portion 112 may make the display portion 12 display that there is the arrival. Furthermore, the display portion 12 may be made to display a sender of the above-described arrival, and a title of the mail etc. if the arrival is of the mail. The display control portion 112 may control operations of the notification portion 13 and the vibrator 16 in addition to the display on the display portion 12. In a case where the display control portion 112 can acquire that there is arrival etc. of the telephone/mail to the smartphone 5, for example, the display control portion 112 may make the notification portion 13 blink and the vibrator 16 vibrate. Furthermore, the display control portion 112 controls the display portion 12, the notification portion 13 and the vibrator 16 based on the user operation that the input portion 17 received. If the user operation is notified from the input portion 17, for example, the display control portion 112 switches the turning on/off of the display on the display portion 12, and changes outline display/detailed display of the information concerning the electronic money settlement and the arrival to the smartphone 5 that are to be displayed on the display portion 12. Furthermore, if the input portion 17 receives a notification stopping operation from the user, the display control portion 112 stops the blink of the notification portion 13 and the vibration of the vibrator 16.

The display direction control portion 1121 controls the display direction of the displaying content on the display portion 12, and controls the display direction of the displaying content on the display portion 12 especially according to the putting-on state, that is, how the terminal 1 is put on. That is, the display direction control portion 1121 controls the display direction of the displaying content on the display portion 12 depending on whether the terminal 1 is put on is the left arm or the right arm and whether the display portion 12 is located in the inside or the outside of the arm when putting the terminal 1 on the arm. The display direction control portion 1121 acquires information concerning the putting-on state of the terminal 1 from the input portion 17.

### (About Information Stored in the Storing Portion)

The basic display information 151 is information including the ID information of the first communication control portion 111, and is an ID of the FeliCa (registered trademark) chip, for example. The information including the ID information of the first communication control portion 111 is stored in the storing portion 15 as the basic display information 151 in a manufacturing process of the terminal 1. Therefore, even in a case where the display control portion 112 and the first communication control portion 111 cannot perform communication with each other and thus the display control portion 112 cannot acquire the ID of the first communication control portion 111 from the first communication control portion 111, the display control portion 112 can display the ID of the first communication control portion 111 on the display portion 12. The display control portion 112 reads the basic display information 151 comprising the ID of the first communication control portion 111 from the storing portion 15 at the time of settlement, for example. Therefore, the display control portion 112 can display the ID of the first communication control portion 111 on the display portion 12 without acquiring the ID of the first communication control portion 111 from the first communication control portion 111.

That is, in a case where the ID (identification information) of the NFC antenna 11 that is a FeliCa (registered trademark) antenna is stored in the storing portion 15 as the basic display information 151 in a production process of the terminal 1, for example, the terminal 1 can perform the following processing. That is, in the terminal 1, even in a case where connection between the NFC antenna 11 and the control portion 10 cannot be performed, it is possible to display on the display portion 12 the ID of the NFC antenna 11, more correctly, an ID (identification information of the noncontact IC chip) of the first communication control portion 111.

### (Content Displayed on the Display Portion)

As described above, at the time of settlement, for example, the display control portion 112 reads the basic display information 151 from the storing portion 15 and displays the ID of the first communication control portion 111 on the display portion 12. Furthermore, at the time except the settlement, the display control portion 112 may display the time and day on the display portion 12. The display control portion 112 may acquire the data of the balance information 1111 in the electronic money, the billing information at the time of electronic settlement, etc. that are stored in the internal memory of the first communication control portion 111, and display the data concerned on the display portion 12. Furthermore, although details will be described later, in a case where the terminal 1 can perform the communication with the smartphone 5, the display control portion 112 may make the display portion 12 display information that the smartphone 5 has and information that the smartphone 5 can acquire. For example, it may be displayed that there is the arrival of the telephone/mail to the smartphone 5, etc., and the sender of the arrival may be displayed, and the title of the mail etc. may be displayed if the arrival is of the mail. Furthermore, at least one of the balance information 1111 and the billing information from WEB via the smartphone 5 may be acquired, and at least one of the balance information 1111 and the billing information may be displayed on the display portion 12. That is, in a case where the terminal 1 can perform the communication with the smartphone 5, the display control portion 112 may make the display portion 12 display the information acquirable from the smartphone 5. However, since a size of the display portion 12 of the terminal 1 is smaller than a display portion of the smartphone 5, it is more desirable that information to be displayed on the display portion 12 is information indicating an outline of the information displayed on the display portion of the smartphone 5. The user can efficiently confirm the information by grasping an outline by using the information displayed on the display portion 12 of the terminal 1, and making the display portion of the smartphone 5 display details when wishing to know the details.

### (Processing Contents)

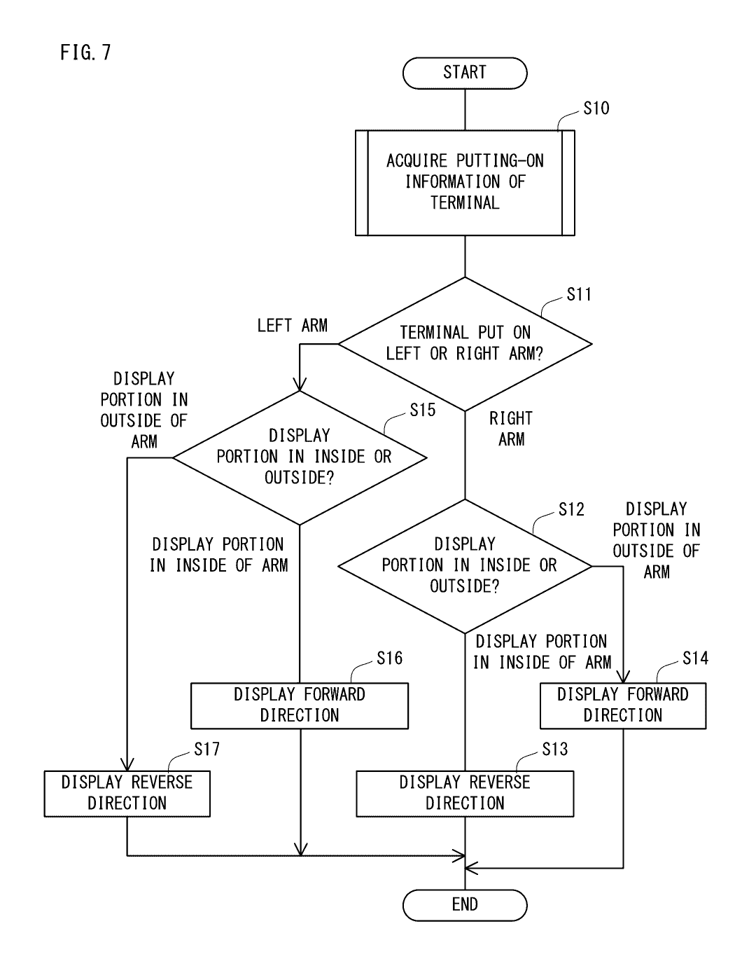

FIG. 7 is a flowchart showing a procedure of processing of the terminal 1. If the user operates the input portion 17 and inputs whether the terminal 1 is to be put on the left or right arm and whether the display portion 12 is located in the inside of the arm (palm side) or the outside of the arm (back of hand side) when putting on it, the display direction control portion 1121 performs the following processing.

The display direction control portion 1121 first acquires from the input portion 17 the putting-on state of the terminal 1, that is, information concerning whether the terminal 1 is put on is the right arm or the left arm of the user and whether the display portion 12 exists in the inside or the outside of the arm when putting the terminal 1 on the arm (S10).

If the putting-on state of the terminal 1 is acquired from the input portion 17, the display direction control portion 1121 judges whether the user puts the terminal 1 on the left or right wrist, that is, whether putting on the right arm or putting on the left arm (S11). In a case where it is judged that the terminal 1 is put on the right arm (right arm at S11), the display direction control portion 1121 next judges whether the terminal 1 is put on such that the display portion 12 comes to the inside the right arm (palm side) or comes to the outside (back of hand side) of the right arm (S12). In a case where it is judged that the display portion 12 comes to the inside the right arm (inside at S12), the display direction control portion 1121 makes the display portion 12 display information in the reverse direction, that is, makes the display direction of the content displayed on the display portion 12 be the reverse direction (S13). Therefore, when looking at the display portion 12 from the user, the displaying content on the display portion 12 is indicated from the upper left to the lower right sequentially. In a case where it is judged that the display portion 12 comes to the outside the right arm (outside at S12), the display direction control portion 1121 makes the display portion 12 perform display in the forward direction, that is, makes the display direction of the content displayed on the display portion 12 be the forward direction (S14). Therefore, when looking at the display portion 12 from the user, the displaying content on the display portion 12 is indicated from the upper left to the lower right sequentially.

In a case where it is judged that the terminal 1 is put on the left arm based on the putting-on state of the terminal 1 acquired from the input portion 17 (left arm at S11), the display direction control portion 1121 judges whether the display portion 12 is the palm side or the back of hand side when putting the terminal 1 on the left hand (S15). In a case where it is judged that the terminal 1 is put on such that the display portion 12 comes to the palm side of the left arm (inside at S15), the display direction control portion 1121 makes the display portion 12 perform display in the forward direction, that is, makes the display direction of the content displayed on the display portion 12 be the forward direction (S16). Therefore, when looking at the display portion 12 from the user, the displaying content on the display portion 12 is indicated from the upper left to the lower right sequentially. In a case where it is judged that the terminal 1 is put on such that the display portion 12 comes to the back of hand side of the left arm (outside at S15), the display direction control portion 1121 makes the display portion 12 perform display in the reverse direction, that is, makes the display direction of the content displayed on the display portion 12 be the reverse direction (S17). Therefore, when looking at the display portion 12 from the user, the displaying content on the display portion 12 is indicated from the upper left to the lower right sequentially.

It is possible to rearrange the above-described description as follows. That is, a control method of the terminal 1 includes a display direction control step (S11-S17) that controls the display direction of the displaying content on the display portion 12 according to whether the terminal 1 is put on is the right arm or the left arm of the user and whether the display portion exists in the inside or the outside of the arm when putting the terminal 1 on the arm.

In addition, in the above-described description, it is assumed that the display direction control portion 1121 acquires from the input portion 17 the information concerning whether the terminal 1 is put on is the right arm or the left arm of the user and whether the display portion 12 exists in the inside or the outside of the arm when putting the terminal 1 on the arm at S10. However, it is not necessary to acquire simultaneously information concerning whether the terminal 1 is put on is the right arm or the left arm of the user and information concerning whether the display portion 12 exists in the inside or the outside of the arm when putting the terminal 1 on the arm. For example, the display direction control portion 1121 may perform a judgement at S11 by acquiring only information concerning whether the terminal 1 is put on is the right arm or the left arm of the user earlier. After the judgement processing at S11, the information concerning whether the display portion 12 exists in the inside or the outside of the arm when putting the terminal 1 on the arm may be acquired. Furthermore, it is not necessary to perform judgement (S11) on whether the terminal 1 is put on is the right arm or the left arm of the user prior to judgement (S12 and S15) on whether the display portion 12 exists in the inside or the outside of the arm when putting the terminal 1 on the arm. That is, it is first judged whether the display portion 12 exists in the inside or the outside of the arm when putting the terminal 1 on the arm. Then, after the above-described judgement, it may be judged whether the terminal 1 is put on is the right arm or the left arm of the user for each of two cases that the display portion 12 exists in the inside of the arm and that the display portion 12 exists in the outside of the arm. That is, an order of the two judgements does not matter as far as the display direction control portion 1121 can perform the two judgements on whether the terminal 1 is put on is the right arm or the left arm of the user and whether the display portion 12 exists in the inside or the outside of the arm when putting the terminal 1 on the arm. Furthermore, as far as the above-described two judgements can be performed, as for the information about whether the terminal 1 is put on is the right arm or the left arm of the user and the information about whether the display portion 12 exists in the inside or the outside of the arm when putting the terminal 1 on the arm, either of both may be acquired earlier, or may be acquired at the same time.

### Embodying Form 2

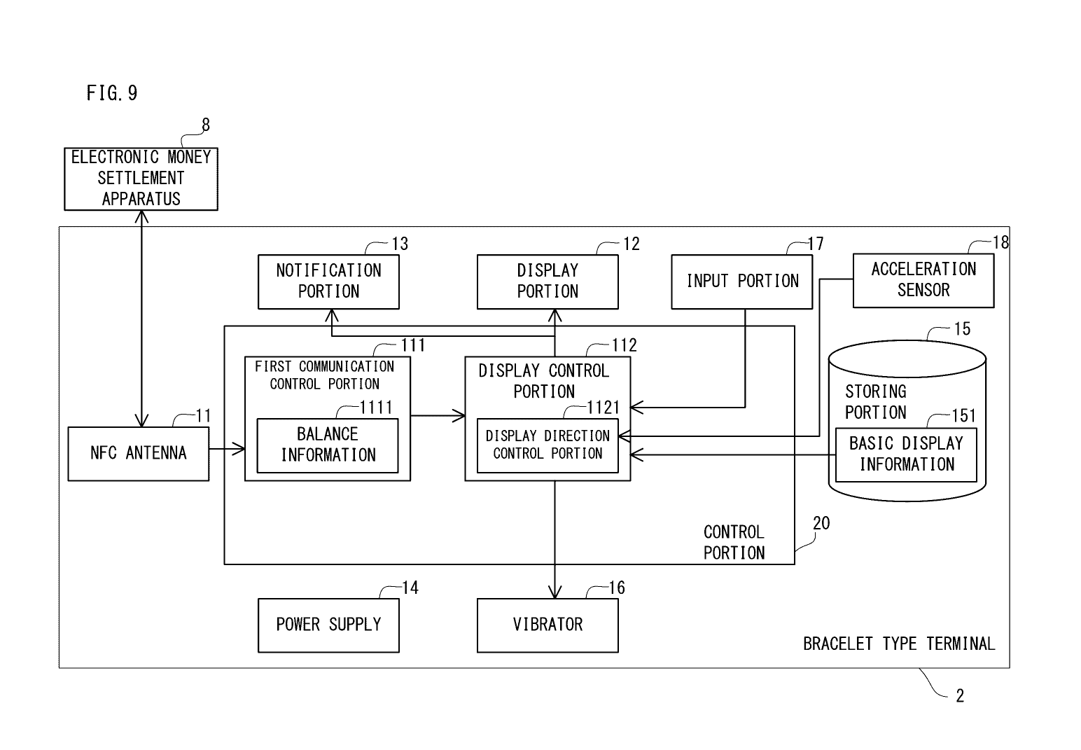

Based on FIG. 9, a further embodying form of the present invention will be described in the following. In addition, for convenience of description, about members having the same functions as those of members having been described in each embodying form described above, a description thereof is omitted here by applying the same reference symbols.

FIG. 9 is a block diagram showing an example of essential structure of a bracelet type communication terminal 2 (hereinafter, simply referred as terminal 2) according to this embodying form. The terminal 2 comprises an acceleration sensor 18 that detects an acceleration of the terminal 2. Then, the display direction control portion 1121 of the terminal 2 judges, based on a detection result that is acquired from the acceleration sensor 18, whether the terminal 2 is put on is the right arm or the left arm of the user and whether the display portion 12 exists in the inside or the outside of the arm when putting the terminal 2 on the arm. The display direction control portion 1121 controls the display direction of the displaying content on the display portion 12 based on a result to the above-described judgement. That is, the terminal 2 comprises the acceleration sensor 18 that detects the acceleration of the terminal 2 instead of the input portion 17 in comparison with the terminal 1.

The acceleration sensor 18 is a sensor that detects a movement of the terminal 2. The movement of the terminal 2 differs depending on whether the terminal 2 is put on the left or right arm and whether the display portion 12 exists in the inside or the outside of the arm when putting on the terminal 2, and therefore, the detection result of the acceleration sensor 18 also differs. According to the difference in the detection result of the acceleration sensor 18, the display direction control portion 1121 judges whether the terminal 2 is put on the left or right arm and whether the display portion 12 exists in the inside or the outside of the arm when putting on the terminal 2. Then, according to a judgement result, the display direction of the displaying content on the display portion 12 is controlled. In addition, the acceleration sensor 18 may be a sensor that just outputs different detection results depending on whether the terminal 2 is put on the left or right arm and whether the display portion 12 exists in the inside or the outside of the arm when putting on the terminal 2, and it is not limited to acceleration sensor. As the acceleration sensor 18, an angular velocity sensor (gyro sensor) that detects inclination of the terminal 2 may be used, for example. That is, the acceleration sensor 18 is sufficient a sensor capable of notifying detection results necessary for judging by the display direction control portion 1121 whether the terminal 2 is put on the left or right arm and whether the display portion 12 exists in the inside or the outside of the arm when putting on it.

In addition, in a case where the horizontal-writing display is performed on the display portion 12, a detection result that the acceleration sensor 18 notifies to the display direction control portion 1121 may not necessarily be what concerning the left or right arm and the inside or outside of the arm as described above, it may be what notifies a gravity direction at the time of walking, for example. In this case, by assuming the gravity direction at the time of walking an upper side of the display, it is possible to perform the display that is legible for the user when visually recognizing the display portion 12. That is, the gravity direction is detected in a state where an arm is fallen along a body at the time of walking, for example, and the gravity direction is assumed an upper direction (upper side) of the display portion 12 of the terminal 2 that is put on the wrist. By setting up the display direction on the display portion 12 as described above, in a case where the user brings the terminal 2 that is put on the wrist close to a face in order to try to confirm the display portion 12, the displaying content on the display portion 12 is displayed in a display direction natural for the user. In addition, by detecting the gravity direction at any time, a direction opposite to the gravity direction may be assumed the upper side of the display at the time that the user bends the arm to bring the terminal 2 that is put on the wrist close to the face, for example.

In the terminal 1, the display direction control portion 1121 acquires from the input portion 17 the putting-on state of the terminal 1, that is, the information about whether the terminal 1 is put on the left or right arm (wrist) and whether the display portion 12 exists in the inside or outside of the arm when putting on it. Then, the display direction control portion 1121 judges, based on the information on the putting-on state of the terminal 1 acquired from the input portion 17, whether the terminal 1 is put on the left or right arm and whether the display portion 12 exists in the inside or outside of the arm when putting on the terminal 1. Then, the display direction of the displaying content on the display portion 12 is controlled based on the result of the above-described judgement.

In contrast, the display direction control portion 1121 of the terminal 2 judges, based on the detection result of the acceleration sensor 18, whether the terminal 2 is put on the left or right arm and whether the display portion 12 exists in the inside or outside of the arm when putting on the terminal 2. Then, the display direction of the displaying content on the display portion 12 is controlled based on the result of the above-described judgement. Therefore, it is unnecessary for the user to notify to the terminal 2, by operating the input portion 17, selection on whether the terminal 2 is to be put on the left or right arm and whether the display portion 12 exists in the inside or outside of the arm when putting on the terminal 2, and thus, the convenience improves.

In addition, if the processing of the terminal 2 is rearranged using FIG. 7, it will be as follows. More specifically, while the display direction control portion 1121 of the terminal 1 acquires the putting-on state of the terminal 1 from the input portion 17, the display direction control portion 1121 of the terminal 2 acquires the detection result concerning the movement of the terminal 2 from the acceleration sensor 18. Then, the display direction control portion 1121 of the terminal 2 performs judgements at S11, S12 and S15 based on the above-described detection result acquired from the acceleration sensor 18. Since the processing of the display direction control portion 1121 after acquiring the detection result concerning the movement of the terminal 2 from the acceleration sensor 18 is the same or similar to the processing after S11 of the terminal 1, a description thereof is omitted.

### Embodying form 3

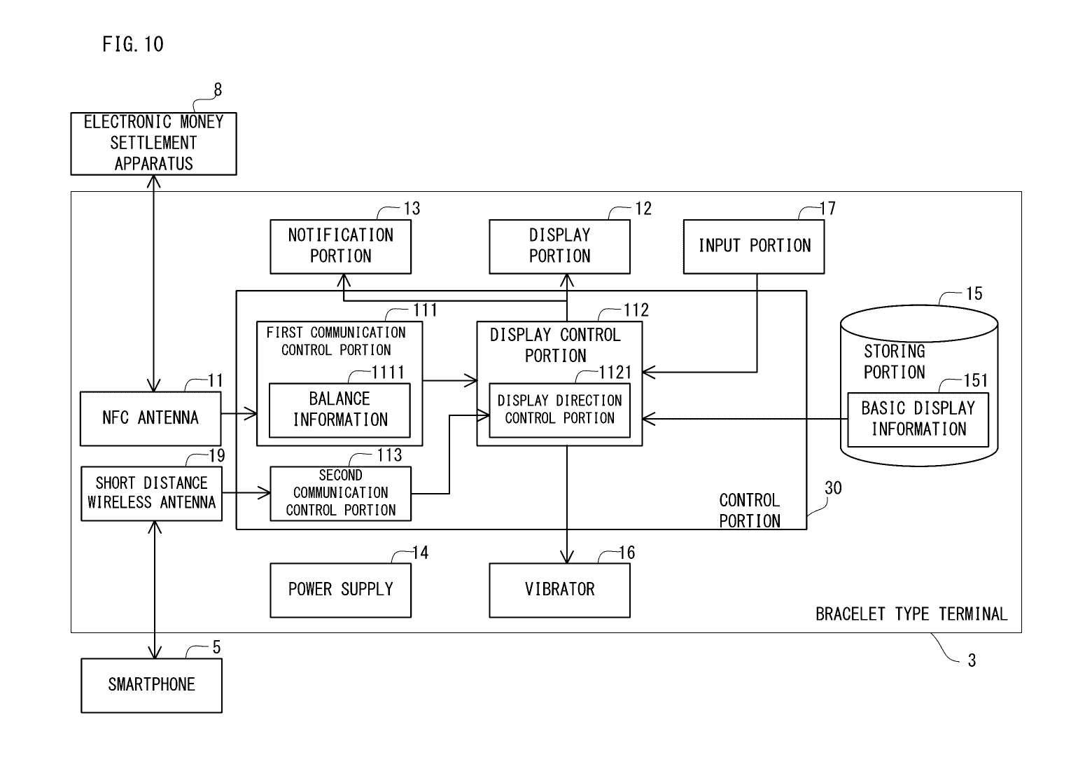

Based on FIG. 10, a further embodying form of the present invention will be described in the following. In addition, for convenience of description, about members having the same functions as those of members having been described in each embodying form described above, a description thereof is omitted here by applying the same reference symbols.

FIG. 10 is a block diagram showing an example of essential structure of a bracelet type communication terminal 3 (hereinafter, simply referred as terminal 3) according to this embodying form. The terminal 3 further comprises a short distance wireless antenna 19 (second antenna) for performing communication with the smartphone 5 (external setting apparatus). Then, the display direction control portion 1121 of the terminal 3 acquires from the smartphone 5 via the short distance wireless antenna 19 information about whether the terminal 3 is put on is the right arm or the left arm of the user and whether the display portion 12 exists in the inside or the outside of the arm when putting on the terminal 3. Subsequently, the display direction control portion 1121 controls the display direction of the displaying content on the display portion 12 based on the above-described information. That is, in addition to the structure of the terminal 1, the terminal 3 is further provided with the short distance wireless antenna 19 and a second communication control portion 113.

The short distance wireless antenna 19 is an antenna for performing communication with an external setting apparatus such as the smartphone 5, and is a Bluetooth (registered trademark) antenna, for example. However, the short distance wireless antenna 19 has only to perform communication with the external setting apparatus, and is not limited to a Bluetooth (registered trademark) antenna. It may be the one that performs short distance wireless communication based on telecommunication standard such as ZigBee (registered trademark), UWB (Ultra Wideband) or WiFi (registered trademark), for example. Furthermore, it may be the one that performs short distance wireless communication in an infrared ray system such as IrDA (infrared Data Association) etc. Furthermore, a communication system is not limited to the short distance wireless communication, and an antenna that can perform communication with the external setting apparatus such as the smartphone 5 is sufficient. That is, although it is assumed that the smartphone 5 performs the short distance wireless communication with the terminal 3 via the short distance wireless antenna 19 in this embodying form, a system of the communication that the smartphone 5 performs to the terminal 3 is arbitrary as far as setting information can be transmitted to the terminal 3. As long as the smartphone 5 and the terminal 3 can communicate, it may not be the short distance wireless communication, but may be a cable system that is connected at the time of communication.

The second communication control portion 113 performs short distance wirelesses communication with an external setting apparatus such as the smartphone 5 via the short distance wireless antenna 19. In addition, the second communication control portion 113 notifies information from the smartphone 5 that is received via the short distance wireless antenna 19 to the display direction control portion 1121. In a case where the smartphone 5 can acquire the information concerning the balance information 1111 of the user and information concerning an amount paid at the time of electronic settlement, etc. from Web, the display control portion 112 may display the information concerning the balance information 1111, the amount paid, etc. on the display portion 12. That is, the billing information etc. may be displayed on the display portion 12 in cooperation with a server. Furthermore, in a case where there is an arrival of the telephone/mail to the smartphone 5, if the second communication control portion 113 can acquire the information concerning such an arrival via the short distance wireless antenna 19, the terminal 3 may notify the user that there is the arrival. That is, the display control portion 112 that is notified from the second communication control portion 113 that there is the above-described arrival to the smartphone 5 may make the display portion 12, the notification portion 13 and the vibrator 16 perform the following operations. The display control portion 112 may make the display portion 12 display that there is the above-described arrival, the notification portion 13 blink, and the vibrator 16 vibrate. Furthermore, the display control portion 112 may make the display portion 12 display the sender of the above-described arrival, and the title of the mail etc. if the above-described arrival is of the mail.

The display direction control portion 1121 of the terminal 3 acquires the putting-on state of the terminal 3 from the smartphone 5 via the short distance wireless antenna 19. If the user inputs to the smartphone 5 the information about whether the terminal 3 is put on is the right arm or the left arm of the user and whether the display portion 12 exists in the inside or the outside of the arm when putting on the terminal 3, for example, the terminal 3 performs the following processing. More specifically, the display direction control portion 1121 acquires from the smartphone 5 via the short distance wireless antenna 19 the information about whether the terminal 3 is put on is the right arm or the left arm of the user and whether the display portion 12 exists in the inside or the outside of the arm when putting on the terminal 3. Then, the display direction of the displaying content on the display portion 12 is controlled based on the above-described information. That is, if the processing of the terminal 3 is rearranged by using FIG. 7, it will be as follows. More specifically, while the display direction control portion 1121 of the terminal 1 acquires the putting-on state of the terminal 1 from the input portion 17, the display direction control portion 1121 of the terminal 3 acquires the putting-on state of the terminal 3 from the smartphone 5 via the short distance wireless antenna 19. Then, the display direction control portion 1121 of the terminal 3 performs judgements at S11, S12 and S15 based on the putting-on state of the terminal 3 acquired from the smartphone 5. Since the processing of the display direction control portion 1121 after acquiring the putting-on state of the terminal 3 from the smartphone 5 is the same or similar to the processing after S11 of the terminal 1, a description thereof is omitted.

Therefore, the terminal 3 acquires from the smartphone 5 the information concerning selection on whether the terminal 3 is put on the left or right arm and whether the display portion 12 exists in the inside or the outside of the arm when putting on the terminal 3, and controls the display direction of the content displayed on the display portion 12 based on the information concerned.

Furthermore, since the terminal 3 can communicate data with the smartphone 5, it can acquire the balance information 1111 etc., for example via the smartphone 5, and can make the display portion 12 display these pieces of information.

### Embodying form 4

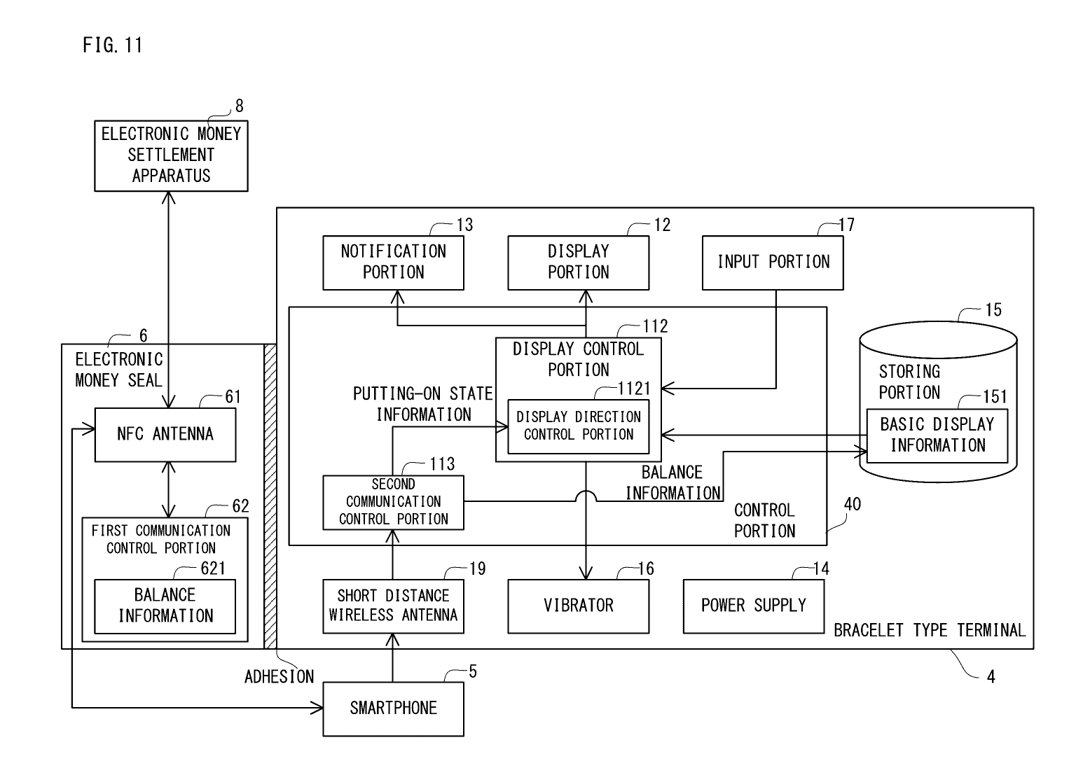

Based on FIGS. 11-13, a further embodying form of the present invention will be described in the following. In addition, for convenience of description, about members having the same functions as those of members having been described in each embodying form described above, a description thereof is omitted here by applying the same reference symbols.

FIG. 11 is a block diagram showing an example of essential structure of a bracelet type communication terminal 4 (hereinafter, simply referred as terminal 4) according to this embodying form. An electronic money seal 6 that performs short distance noncontact wireless communication with the electronic money settlement apparatus 8 is attached to the terminal 4 such that an NFC antenna 61 of the electronic money seal 6 is located in the little finger side (ulna side) of the arm of the user that the terminal 4 is put on. It is thinkable that as a method of attaching the electronic money seal 6 to the terminal 4, the electronic money seal 6 is adhered to the terminal 4, for example. However, an attaching method is not limited to adhesion, and it may be an arbitrary method if it is a method that the electronic money seal 6 can be attached to the terminal 4 such that the NFC antenna 61 is located in the little finger side (ulna side) of the arm of the user that the terminal 4 is put on. In addition to a control portion 40, the terminal 4 comprises the display portion 12, the notification portion 13, the power supply 14, the storing portion 15, the vibrator 16, the input portion 17 and the short distance wireless antenna 19 that are the same or similar to those of the terminal 3. Furthermore, the control portion 40 of the terminal 4 comprises the display control portion 112 and the second communication control portion 113 that are the same or similar to those of the control portion 30 of the terminal 3. Because the display portion 12, the notification portion 13, the power supply 14, the storing portion 15, the vibrator 16, the input portion 17, the short distance wireless antenna 19, the display control portion 112 and the second communication control portion 113 are the same or similar to those having been described until now, details thereof are omitted here. Describing an outline, the display direction control portion 1121 of the display control portion 112 acquires from the smartphone 5 via the short distance wireless antenna 19 the information about whether the terminal 4 is put on is the right ram or the left arm of the user and whether the display portion 12 is in the inside or the outside of the arm when putting on the terminal 4. Then, the display direction of the displaying content on the display portion 12 is controlled based on the above-described information.

Unlike the structure of the terminal 3, the terminal 4 does not comprise the NFC antenna 11 and the first communication control portion 111, instead, the electronic money seal 6 comprising the NFC antenna 61 (the first communication portion) and a first communication control portion 62 is adhered to the terminal 4. More specifically, the electronic money seal 6 is adhered to the terminal 4 such that the NFC antenna 61 of the electronic money seal 6 is located in the little finger side (ulna side) of the arm of the user that puts on the terminal 4. The NFC antenna 61 is a FeliCa (registered trademark) antenna, for example, and the first communication control portion 62 is a FeliCa (registered trademark) chip, for example. Various kinds of information such as ID information of the FeliCa (registered trademark) chip, balance information 621, etc., are stored in a memory of the first communication control portion 62. Then, the user can perform an electronic settlement by bringing the NFC antenna 61 of the electronic money seal 6 arranged at the ulna side of the terminal 4 that is put on the arm close to the electronic money settlement apparatus 8.

Here, an application for smartphone for reading the information concerning the electronic settlement performed with using the FeliCa (registered trademark) chip from the FeliCa (registered trademark) chip is already common under a name of an “electronic money reader” etc. The smartphone 5 can read from the electronic money seal 6 comprising the first communication control portion 62 that is a FeliCa (registered trademark) chip the information concerning the electronic settlement that the user performs by using the electronic money seal 6 with utilizing the above-described application, for example.

The terminal 4 can communicate data with the smartphone 5, that is, it can acquire various kinds of information that the smartphone 5 holds. If the smartphone 5 acquires information such as money receipt information concerning the electronic money seal 6, billing information, balance information 621, ID information of the FeliCa (registered trademark) chip, etc. from the electronic money seal 6 by using the above-described application, for example, the terminal 4 performs the following processing. That is, the terminal 4 can acquire from the smartphone 5 via the short distance wireless antenna 19 the above-described information such as the balance information 621 etc. that the smartphone 5 acquires, and can make the display portion 12 display it.

Furthermore, the terminal 4 acquires from the smartphone 5 via the short distance wireless antenna 19 the information about whether the terminal 4 that is adhered with the electronic money seal 6 is put on is the right ram or the left arm of the user and whether the display portion 12 is in the inside or the outside of the arm when putting on the terminal 4. Then, the display direction control portion 1121 controls the display direction of the displaying content on the display portion 12 based on the above-described information.

As described above, the terminal 4 according to this embodying form is not provided with the NFC antenna and communication control portion for performing the electronic settlement while being brought close to the electronic money settlement apparatus 8, instead, it is adhered with the electronic money seal 6 comprising the NFC antenna 61 and the first communication control portion 62. Therefore, the terminal 4 has structure that the control portion 40 and the first communication control portion 62 of the electronic money seal 6 cannot perform communication directly with each other. However, the terminal 4 can acquire via the smartphone 5 information including the balance information 621 etc. stored in the memory of the first communication control portion 62, and can display it on the display portion 12. Then, a position where the NFC antenna 61 of the electronic money seal 6 is arranged on the terminal 4 exists in the ulna side of the arm in a state where the terminal 4 is put on the arm of the user. Furthermore, the terminal 4 controls the display direction of the displaying content on the display portion 12 according to whether the terminal 4 is put on the right arm or the left arm of the user and whether the display portion 12 exists in the inside or the outside of the arm when putting the terminal 4 on the arm. Accordingly, according to the terminal 4, the user can perform short distance noncontact wireless communication with a natural posture, and without depending on whether the terminal 4 is put on the right arm or the left arm of the user and whether the display portion 12 exists in the inside or the outside of the arm when putting on it, it is possible to perform display in a display direction natural for the user.

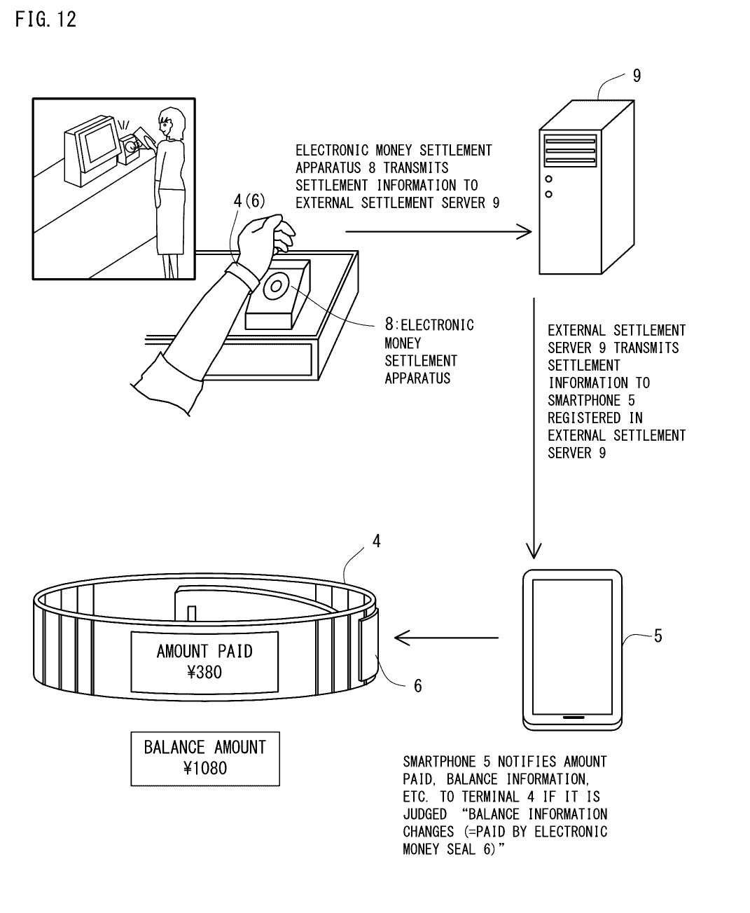

FIG. 12 is a view showing an outline of an electronic money settlement system comprising the terminal 4. In the electronic money settlement system exemplified in FIG. 12, if it is judged that the balance information 621 on the electronic money seal 6 is changed (the user performs a settlement by holding up the terminal 4 to the electronic money settlement apparatus 8), the smartphone 5 notifies the balance information 621 after change to the terminal 4. As a result, the balance information 621 after settlement (that is, after change) is displayed on the display portion 12 of the terminal 4. In the following, processing of the electronic money settlement apparatus 8, the smartphone 5, and the terminal 4 in the electronic money settlement system shown in FIG. 12 will be described.

In FIG. 12, if the user performs settlement by the electronic money by holding the terminal 4 (more correctly, the electronic money seal 6 put on the terminal 4) up to the electronic money settlement apparatus 8, the electronic money settlement apparatus 8 first transmits the information on the settlement (settlement information) to an external settlement server 9. The above-described settlement information is the balance information 621 on the electronic money seal 6 after the above-described settlement, an amount paid in the above-described settlement, etc., for example.

The settlement server 9 is registered with the smartphone 5 in advance, and also stored with the balance information 621 on the electronic money seal 6 before the above-described settlement. The settlement server 9 transmits the above-described settlement information to the smartphone 5 that is registered in the settlement server 9 if the above-described settlement information is received from the electronic money settlement apparatus 8.

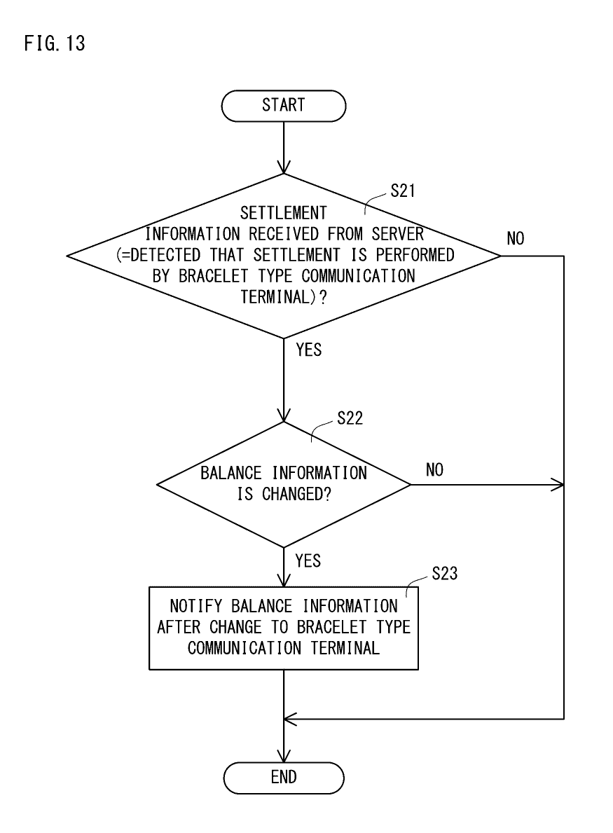

The smartphone 5 receives the above-described settlement information from the settlement server 9. Then, it is judged whether “the balance information 621 on the electronic money seal 6 is changed (that is, the user performs a settlement by electronic money using the terminal 4).” About judgement processing performed by the smartphone 5, details will be described later using FIG. 13. If it is judged “the balance information 621 on the electronic money seal 6 is changed”, the smartphone 5 notifies the above-described settlement information to the terminal 4, and the terminal 4 that acquires the above-described settlement information from the smartphone 5 displays the above-described settlement information on the display portion 12.

According to the electronic money settlement system exemplified in FIG. 12, even if the NFC antenna 61 and the control portion 40 of the terminal 4 are not connected to each other, that is, even in a case where the terminal 4 and the electronic money seal 6 cannot perform communication with each other directly, the user can confirm on the terminal 4 the information (the balance, the amount paid, etc.) concerning the electronic money settlement performed by using the electronic money seal 6. Therefore, the user can confirm the information concerning the above-described settlement by only looking at the display portion 12 of the terminal 4 that is put on the arm without performing an operation of “taking out the smartphone 5 from a bag and starting the application for confirming the information concerning settlement with the smartphone 5”.

FIG. 13 is a flowchart showing a procedure of processing of the smartphone 5 in the electronic money settlement system of FIG. 12.

The smartphone 5 judges whether the settlement information (information concerning the electronic money settlement performed between the electronic money seal 6 and the electronic money settlement apparatus 8) is received from the settlement server 9 (S21). In addition, as described above, if the electronic money settlement is performed between the electronic money seal 6 and the electronic money settlement apparatus 8, the electronic money settlement apparatus 8 transmits the information concerning the settlement (including for example, the balance information 621 of the electronic money seal 6, the amount paid, etc. after the settlement) to the settlement server 9. Then, the settlement server 9 transmits the information concerning the above-described settlement (settlement information) received from the electronic money settlement apparatus 8 to the smartphone 5.

The smartphone 5 judges whether the balance information 621 on the electronic money seal 6 is changed (S22) when it is judged that the above-described settlement information is received from the settlement server 9 (Yes at S21). That is, it is judged whether the balance information 621 on the electronic money seal 6 included in the above-described settlement information acquired from the settlement server 9 is different from the balance information 621 on the electronic money seal 6 that the smartphone 5 grasps before acquisition of the above-described settlement information. Then, if it is judged that the balance information 621 on the electronic money seal 6 changes (Yes at S22), the smartphone 5 notifies the balance information 621 etc. after change (after the settlement) to the terminal 4 (S23).

The smartphone 5 terminates the processing in a case where it is judged that the above-described settlement information is not received from the settlement server 9 (No at S21) or in a case where it is judged that the balance information 621 on the electronic money seal 6 is not changed (No at S22).

In addition, as to a judgement on whether “the balance information 621 on the electronic money seal 6 is changed”, in the above description, it is assumed that the smartphone 5 compares the balance information 621 on the electronic money seal 6 before acquiring the above-described settlement information from the settlement server 9 with the balance information 621 on the electronic money seal 6 included in the above-described settlement information acquired from the settlement server 9. Then, in a case where the balance information 621 on the electronic money seal 6 before acquiring the above-described settlement information from the settlement server 9 and the balance information 621 on the electronic money seal 6 included in the above-described settlement information acquired from the settlement server 9 are different from each other, the smartphone 5 judges that “the balance information 621 on the electronic money seal 6 is changed.” However, a method of judging whether “the balance information 621 on the electronic money seal 6 is changed” is not limited to this.

For example, the settlement server 9 may compare the balance information 621 on the electronic money seal 6 before acquiring the above-described settlement information from the electronic money settlement apparatus 8 with the balance information 621 on the electronic money seal 6 included in the above-described settlement information acquired from the electronic money settlement apparatus 8. Then, the settlement server 9 may transmit to the smartphone 5 a result of the above-described comparison in addition to the above-described settlement information. The smartphone 5 may judge whether “the balance information 621 on the electronic money seal 6 changes” based on the result of the above-described comparison received from the settlement server 9, and may decide whether the above-described settlement information is transmitted to the terminal 4.

That is, what is necessary for the smartphone 5 is just to judge whether the balance information 621 on the electronic money seal 6 included in the above-described settlement information transmitted from the electronic money settlement apparatus 8 and the balance information 621 on the electronic money seal 6 before being transmitted the above-described settlement information from the electronic money settlement apparatus 8 are different from each other. If it is judged that the balance information 621 on the electronic money seal 6 included in the above-described settlement information acquired from the electronic money settlement apparatus 8 and the balance information 621 on the electronic money seal 6 before acquiring the above-described settlement information from the electronic money settlement apparatus 8 are different from each other, the smartphone 5 judges that the settlement by the electronic money seal 6 is performed. Then, the smartphone 5 notifies the above-described settlement information including the balance information 621 on the electronic money seal 6 after the above-described settlement to the terminal 4.

Therefore, in the terminal 4, the NFC antenna 61 is an antenna of the first communication control portion 62 (noncontact IC chip comprising an electronic money settlement function) that is a FeliCa (registered trademark) chip, for example, and information that is related to the electronic money settlement performed between the first communication control portion 62 and the electronic money settlement apparatus 8 and acquired from the first communication control portion 62 or the electronic money settlement apparatus 8 is displayed on the display portion 12. Specifically, the terminal 4 acquires the information concerning the above-described electronic money settlement (settlement information) that is output from the electronic money settlement apparatus 8 via the smartphone 5, and displays the settlement information concerned on the display portion 12.

### Embodying Form 5

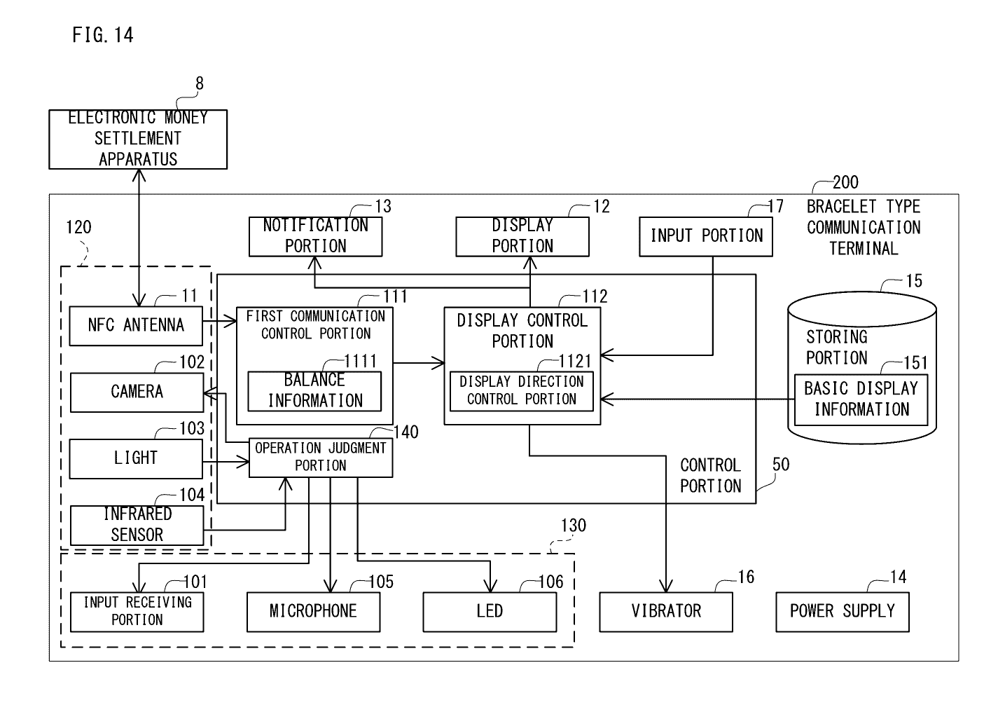

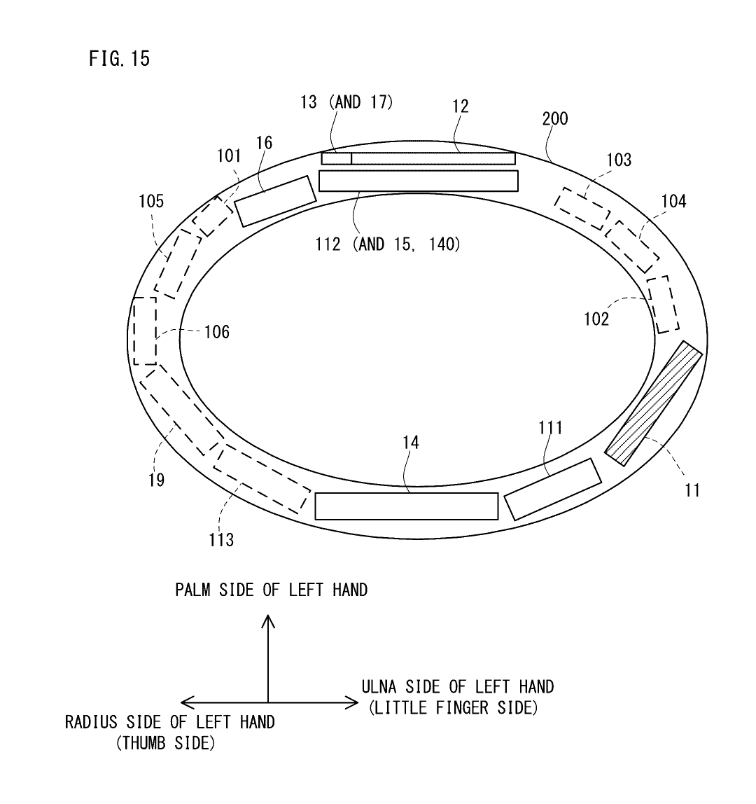

Based on FIGS. 14 and 15, a further embodying form of the present invention will be described in the following. In addition, for convenience of description, about members having the same functions as those of members having been described in each embodying form described above, a description thereof is omitted here by applying the same reference symbols. Firstly describing an outline of the bracelet type communication terminal 200 (hereinafter, simply referred as the terminal 200) according to this embodying form, it is as follows.

That is, the terminal 200 is a communication terminal comprising the display portion 12, and arranged with a first functional portion 120 that is used in a state where the user puts the terminal 200 on the arm while being turned toward a side opposite to a side of the user side, or is arrangeable with the first functional portion 120. Then, the terminal 200 comprises the display direction control portion 1121 that controls the display direction of the displaying content on the display portion 12 according to whether the terminal 200 is put on is the right arm or the left arm and whether the display portion 12 exists in the inside or the outside of the arm when putting the terminal 200 on the arm.

Therefore, in the terminal 200, the user can use the first functional portion 120 with a natural posture, and it is possible to perform display in a display direction natural for the user without depending on whether putting on is the right arm or the left arm and whether the display portion 12 of the terminal 200 exists in the inside or the outside of the arm when putting on it.

Here, the first functional portion 120 is at least any one of the NFC antenna 11 (antenna for performing short distance noncontact wireless communication), a camera 102 (imaging portion), a light 103 (light emitting portion) and an infrared sensor 104 (light receiving portion). Each of the NFC antenna 11, the camera 102, the light 103 and the infrared sensor 104 is the one that the user uses while being turned toward an outside space viewed from the user at the time of use. Therefore, in using at least any one of the NFC antenna 11, the camera 102, the light 103 and the infrared sensor 104, the user can use it without twisting an arm unnaturally, and can confirm the content displayed on the display portion 12 in a natural display direction without depending on the putting-on state of the terminal 200.

Although details will be described later, in the terminal 200, the NFC antenna 11, the camera 102, the light 103 and the infrared sensor 104 are arranged in the belt portion B1. Therefore, the user can put on the terminal 200 such that the NFC antenna 11, the camera 102, the light 103 and the infrared sensor 104 come to the ulna side of the arm. Then, by putting on the terminal 200 such that the NFC antenna 11, the camera 102, the light 103 and the infrared sensor 104 come to the ulna side, when using the NFC antenna 11, the camera 102, the light 103 and the infrared sensor 104, the user does not need to twist the arm unnaturally. Furthermore, when the user looks at the display portion 12 while putting on the terminal 200 such that the NFC antenna 11, the camera 102, the light 103 and the infrared sensor 104 come to the ulna side of the arm, the terminal 200 controls the display direction of the displaying content on the display portion 12 to the display direction natural for the user. Therefore, the user can confirm the content displayed on the display portion 12 in the display direction natural for the user without depending on whether the terminal 200 is put on is the right arm or the left arm, and the terminal 200 can improve convenience and operability for the user. For example, the user can photograph with confirming the display portion 12 as a finder while turning the camera 102 that exists in the ulna side toward the side opposite to the user side. Furthermore, an image photographed is displayed on the display portion 12 in the display direction natural for the user. Furthermore, the user can look at the display portion 12 while turning on the light 103 existing in the ulna side to illuminate an opposite side to the user side (front of the user, for example). In addition, the infrared sensor 104 is a light receiving sensor that is used for sensing a circumstance of the user, for example while turning toward the opposite side to the user, and it may be an illumination sensor, a proximity sensor, etc. Furthermore, the light emitting portion is not limited to the one that emits light in visible light, and may be the one that emits light in invisible ray such as an infrared ray that is used when transmitting information to other apparatuses.

In addition, in the terminal 200, the first functional portion 120 may also include (i) the NFC antenna 11 and (ii) at least one of the camera 102, the light 103 and the infrared sensors 104. That is, as for the first functional portion 120 of the terminal 200, the NFC antenna 11 may be an indispensable component. By assuming the NFC antenna 11 the indispensable component, the user can perform, with using the terminal 200, short distance noncontact wireless communication with a natural posture. Furthermore, the user can use, with the terminal 200, at least one of the camera 102, the light 103 and the infrared sensor 104 with a natural posture. Furthermore, the user can confirm the content displayed on the display portion 12 in a natural display direction without depending on the putting-on state of the terminal 200. In addition, since there is a possibility that a sensitivity of the antenna decreases if a metal is near, in a case where the sensitivity of the NFC antenna 11 decreases due to at least one of the camera 102, the light 103 and the infrared sensor 104, it is desirable to provide with the camera 102, the light 103 and the infrared sensor 104 causing the sensitivity decrease by separating from the NFC antenna 11 by a suitable distance.

Furthermore, the terminal 200 is a communication terminal comprising the display portion 12, and is arranged with a second functional portion 130 that the user uses while being turned toward the user in a state where the user puts the terminal 200 on an arm, or arrangeable with the second functional portion 130, and comprises the display direction control portion 1121 that controls the display direction of the displaying content on the display portion 12 according to whether the terminal 200 is put on is the right arm or the left arm and whether the display portion 12 of the terminal 200 exists in the inside or the outside of the arm when putting the terminal 200 on the arm.

Therefore, in the terminal 200, the user can use the second functional portion 130 with a natural posture, and it is possible to perform the display in a display direction natural for the user without depending on whether putting on is the right arm or the left arm and whether the display portion 12 of the terminal 200 exists in the inside or the outside of the arm when putting on it.

Here, the second functional portion 130 is at least one of an input receiving portion 101 (user input receiving portion), a microphone 105 (user input receiving portion) and an LED 106 (light-emitting notification portion). Each of the input receiving portion 101, the microphone 105 and the LED 106 is used while being turned toward the user at the time of use. Therefore, when the user uses at least one of the input receiving portion 101, the microphone 105 and the LED 106, the user can use without twisting the arm unnaturally, and the user can confirm the content displayed on the display portion 12 in a natural display direction without depending on the putting-on state of the terminal 200.

Although details will be described later, the input receiving portion 101, the microphone 105 and the LED 106 are arranged in the belt portion B1 in the terminal 200. Therefore, the user can put on the terminal 200 such that the input receiving portion 101, the microphone 105 and the LED 106 come to the radius side of the arm. Then, by putting on the terminal 200 such that the input receiving portion 101, the microphone 105 and the LED 106 come to the radius side of the arm, the user does not need to twist the arm unnaturally when using the input receiving portion 101, the microphone 105 and the LED 106. Furthermore, in a case where the user looks at the display portion 12 while putting on the terminal 200 such that the input receiving portion 101, the microphone 105 and the LED 106 come to the radius side of the arm, the terminal 200 controls the display direction of the displaying content on the display portion 12 to a display direction natural for the user. Therefore, the user can confirm the content displayed on the display portion 12 in the display direction natural for the user without depending on whether the terminal 200 is put on is the right arm or the left arm, and the terminal 200 can improve convenience and operability for the user. It is easy for the user to operate the input receiving portion 101 because the input receiving portion 101 that receives the user operation exists in the radius side, for example Because the microphone 105 that receives a voice input from the user exists in the radius side, it is easy for the user to address toward the microphone 105, and the microphone 105 can receive the voice input from the user efficiently. Furthermore, it becomes possible for the user to talk with somebody by turning the microphone 105 that exists in the radius side to the user himself/herself while looking at the display portion 12. Furthermore, it is easy for the user to notice the notification (alert) by blink of the LED 106, etc. even when the user is looking at the display portion 12 because the LED 106 that notifies the user of the arrival of the mail etc. by light exists in the radius side. In addition, the input receiving portion 101 is a button that receives the user operation, for example.

FIG. 14 is a block diagram showing an example of essential structure of the above-described terminal 200. In addition to the structure of the terminal 1 exemplified in FIG. 1 and the terminal 2 exemplified in FIG. 9, the terminal 200 further comprises the camera 102, the light 103, the infrared sensor 104, the input receiving portion 101, the microphone 105 and the LED 106. Furthermore, in addition to the structure of the control portion 10 of the terminal 1 and the control portion 20 of the terminal 2, an operation judgement portion 140 is further included in the control portion 50 of the terminal 200.

The operation judgement portion 140 makes the camera 102 perform predetermined processing, and switches turning on/off of the light 103, or stops blink of the LED 106 according to the user operation received by the input receiving portion 101 and the microphone 105, for example. Furthermore, the LED 106 is one (1) or two or more LEDs that notify the user of the arrival of mail etc. with arrangement patterns or blink patterns, for example.

Each of the NFC antenna 11, the camera 102, the light 103 and the infrared sensor 104 is used in a state where the user puts the terminal 200 on the arm while being turned toward a side opposite to the user side, and thus included in the first functional portion 120. In contrast, each of the input receiving portion 101, the microphone 105 and the LED 106 is used in a state where the user puts the terminal 200 on the arm while being turned toward the user, and thus included in the second functional portion 130. Although details will be described later by using FIG. 15, the first functional portion 120 is arranged in the ulna side of the arm in a state where the terminal 200 is put on the arm of the user. Similarly, the second functional portion 130 is arranged in the radius side of the arm in a state where the terminal 200 is put on the arm of the user.

In addition, the second functional portion 130 may include a speaker portion for notifying the user of a voice. By turning the speaker portion toward the user, it is possible to make surrounding people be hard to hear the voice that the speaker portion outputs, and make only the user be easy to hear the voice.

Furthermore, the second functional portion 130 may include various kinds of measurement sensor portions such as a skin sensor that measures an amount of moisture etc. of a skin of the user and a body temperature sensor that measures a body temperature of the user. Accordingly, it becomes more easy to perform measurement of the amount of moisture and the body temperature while bringing them into contact (close) to another part such as an arm, face, etc., for example.

The NFC antenna 11 is an antenna of the first communication control portion 111 (noncontact IC chip comprising an electronic money settlement function) that is a FeliCa (registered trademark) chip, for example, and information that is related to the electronic money settlement performed between the first communication control portion 111 and the electronic money settlement apparatus 8 and acquired from the first communication control portion 111 or the electronic money settlement apparatus 8 may be displayed on the display portion 12. In addition, in a case where the above-described information acquired from the electronic money settlement apparatus 8 is displayed, the terminal 200 may display the information that is output from the electronic money settlement apparatus 8 via the smartphone 5 etc., as described by using FIG. 12 and FIG. 13.

Furthermore, the ID (identification information of the noncontact IC chip) of the first communication control portion 111 may be displayed on the display portion 12. In a case where the ID of the NFC antenna 11 (more correctly the ID of the first communication control portion 111) is stored in the storing portion 15 in a production process of the terminal 200, for example as the basic display information 151, the terminal 200 can perform the following processing. That is, even in a case where the connection between the NFC antenna 11 and the control portion 50 cannot be performed, the terminal 200 can display the ID of the NFC antenna 11 on the display portion 12.

In addition, if confirming it just to make sure, in the terminal 200, the display direction control portion 1121 controls, as similar to that in the terminal 1, the display direction of the displaying content on the display portion 12 to be looked at naturally from the user. That is, the display direction of the displaying content on the display portion 12 is controlled to be always looked at naturally from the user without depending on the putting-on method of the terminal 200 by the user. Therefore, it becomes possible for the user to confirm the displaying content displayed on the display portion 12 in the display direction that the user looks at naturally while putting on the terminal 200 such that the first functional portion 120 comes to the ulna side of the arm and the second functional portion 130 comes to the radius side of the arm. That is, the user can use the first functional portion 120 and the second functional portion 130 with a natural posture, and can confirm the displaying content displayed on the display portion 12 in the display direction that the user looks at naturally.

FIG. 15 is an explanatory diagram showing an outline of the structure in a cross-section cutting the terminal 200 in a state where the terminal 200 is put on the left arm along a direction from a palm side to a back of hand side. As shown in FIG. 15, the first functional portion 120 (the NFC antenna 11, the camera 102, the light 103 and the infrared sensor 104) and the second functional portion 130 (the input receiving portion 101, the microphone 105 and the LED 106) are arranged in the belt portion B1.

The first functional portion 120 and the second functional portion 130 are arranged in the belt portions B1 opposite to each other while sandwiching the display portion 12. Therefore, the user can put on the terminal 200 while making the first functional portion 120 be located in the ulna side of the arm and the second functional portion 130 be located in the radius side of the arm.

Especially, in the terminal 200, the NFC antenna 11 is arranged in the belt portion B1 that is separated from the display portion 12, and is arranged or arrangeable such that the NFC antenna 11 comes to the little finger side (ulna side) of the arm of the user when the user puts on the terminal 1.

Furthermore, in the terminal 200, the control portion 50 is arranged separately from the NFC antenna 11. By arranging the control portion 50 separately from the NFC antenna 11, the terminal 200 can make its structure thin in comparison with structure that the control portion 50 and the NFC antenna 11 are made to be an integrated type.

### Embodying Form 6

The control portions 10, 20, 30, 40 and 50 (especially, the first communication control portion 111, the display control portion 112, the display direction control portion 1121 and the second communication control portion 113) of the bracelet type communication terminals 1, 2, 3, 4 (terminals 1, 2, 3, 4) and 200 may be implemented by logic circuits (hardware) formed in an integrated circuit (IC chip) etc., or implemented by a software with using a CPU (Central Processing Unit). In the latter case, each of the terminals 1, 2, 3, 4 and 200 comprises a CPU executing instructions of a program that is a software capable of implementing respective functions, a ROM (Read Only Memory) or storing device (these may be called the “recording medium”) that is recorded with the above-described program and various data in a manner readable by a computer (or CPU), a RAM (Random Access Memory) developing thereon the above-described program, etc. Then, when the computer (or CPU) reads the above-described program in the above-described recording medium and executes it, the object of the present invention can be achieved. As the above-described recording medium, it is possible to use “non-transitory tangible medium”, for example, a tape, a disk, a card, a semiconductor memory, a programmable logic circuit, etc. Furthermore, the above-described program may be supplied to the above-described computer via an arbitrary transmission medium (communication network, broadcast wave, etc.) that can transmit the program. In addition, the present invention may be implemented also with a form of a data signal embedded in a subcarrier that the above-described program is embodied by electronic transmission.

### [Summarization]

A communication terminal (bracelet type communication terminals 1, 2, 3, 4 and 200) according to a form 1 of the present invention is a communication terminal comprising a display portion (12) characterized in that a first functional portion (120) to be used in a state where the user puts the above-described communication terminal on an arm while being turned toward an opposite side to a user side is arranged or the first functional portion concerned is arrangeable, and the communication terminal comprises a display direction control portion (1121) configured to control a display direction of a displaying content on the above-described display portion according to whether the above-described communication terminal is put on is a right arm or a left arm of the user and whether the above-described display portion exists in an inside or an outside of the arm when putting the above-described communication terminal on the arm.

According to the above-described structure, in the above-described communication terminal, it is possible for the user to use the above-described first functional portion with a natural posture, and it is possible to perform display in a display direction natural for the user without depending on whether putting on is the right arm or the left arm and whether the display portion of the above-described communication terminal exists in the inside or the outside of the arm when putting on it.

In a communication terminal according to a form 2 of the present invention, the above-described first functional portion of the above-described form 1 may be at least any one of an antenna (NFC antenna 11) for performing short distance noncontact wireless communication, an imaging portion (camera 102), a light emitting portion (light 103) and the light receiving portion (infrared sensor 104).

According to the above-described structure, the first functional portion is at least any one of the antenna for performing short distance noncontact wireless communication, the imaging portion, the light emitting portion and the light receiving portion, and each of them is used by the user while being turned toward an outside space viewed from the user at the time of use.

Therefore, in using at least any one of the antenna for performing short distance noncontact wireless communication, the imaging portion, the light emitting portion and the light receiving portion, the user can use it without twisting the arm unnaturally, and can confirm the content displayed on the above-described display portion in a natural display direction without depending on a putting-on state of the above-described communication terminal.

In a communication terminal according to a form 3 of the present invention, the above-described first functional portion of the above-described form 1 may include (i) an antenna (NFC antenna 11) for performing short distance noncontact wireless communication and (ii) at least one of an imaging portion (camera 102), a light emitting portion (light 103) and the light receiving portion (infrared sensor 104).

According to the above-described structure, in the above-described communication terminal, it is possible for the user to perform short distance noncontact wireless communication with a natural posture, and to use at least one of the imaging portion, the light emitting portion and the light receiving portion with a natural posture, and can confirm the content displayed on the above-described display portion without depending on the putting-on state of the above-described communication terminal. In addition, in a case where the sensitivity of the antenna decreases if a metal is near, it is desirable to provide with at least one of the imaging portion, the light emitting portion and the light receiving portion causing the sensitivity decrease by separating from the antenna by a suitable distance.

A communication terminal (bracelet type communication terminals 1, 2, 3, 4 and 200) according to a form 4 of the present invention is a communication terminal comprising a display portion (12) characterized in that a second functional portion (130) configured to be used in a state where the user puts the communication terminal on an arm while being turned toward the user is arranged or the second functional portion concerned is arrangeable, and that the communication terminal comprises a display direction control portion (1121) configured to control a display direction of a displaying content on the above-described display portion according to whether the above-described communication terminal is put on a right arm or a left arm of the user and whether the above-described display portion exists in an inside or an outside of the arm when putting the above-described communication terminal on the arm.

According to the above-described structure, in the above-described communication terminal, it is possible for the user to use the above-described second functional portion with a natural posture, and it is possible to perform display in a display direction natural for the user without depending on whether putting on is the right arm or the left arm and whether the display portion of the above-described communication terminal exists in the inside or the outside of the arm when putting on it.

In a communication terminal according to a form 5 of the present invention, the above-described second functional portion in the above-described form 4 may be at least any one of a user input receiving portion (at least one of the input receiving portion 101 and the microphone 105), a light emitting notification portion (LED 106), a speaker portion and a measurement sensor portion.

According to the above-described structure, the second functional portion is at least any one of the user input receiving portion, the light emitting notification portion, the speaker portion and the measurement sensor portion, and each of them is used by the user while being turned toward the user at the time of use.

Therefore, in using at least any one of the user input receiving portion, the light emitting notification portion, the speaker portion and the measurement sensor portion, the user can use it without twisting an arm unnaturally, and can confirm the content displayed on the above-described display portion in a natural display direction without depending on the putting-on state of the above-described communication terminal.

A communication terminal (bracelet type communication terminals 1 and 200) according to a form 6 of the present invention further comprises an input portion (17) configured to be selected whether the above-described communication terminal is put on a right arm or a left arm of the user and whether the above-described display portion exists in an inside or an outside of the arm when putting the above-described communication terminal on the arm in any one of the above-described forms 1 to 5, and the above-described display direction control portion may control the display direction of the displaying content on the above-described display portion depending on a selection result that is acquired from the above-described input portion.

According to above-described structure, the above-described display direction control portion acquires a putting-on state of the user, that is, information on whether the above-described communication terminal is put on the left or right arm and whether the above-described communication terminal is put on such that the above-described display portion comes to the inside or the outside of the arm via the above-described input portion. Then, the above-described display direction control portion controls the display direction of the displaying content on the above-described display portion based on the above-described putting-on state. Therefore, by selecting by the input portion whether the above-described communication terminal is put on the left or right arm and whether the above-described terminal is put on such that the above-described display portion comes to the inside or the outside of the arm, the above-described communication terminal can perform display on the above-described display portion in a display direction natural for the user without depending on whether putting on is the left arm or the right arm and whether the above-described display portion comes to the inside of the arm or comes to the outside when putting on it. Furthermore, since the above-described display direction control portion controls the display direction of the displaying content of the above-described display portion based on the putting-on state that is input to the above-described input portion such that the displaying content can be looked at naturally from the user, the user can always put on the above-described communication terminal such that the above-described first antenna is located in the ulna side of the arm. Therefore, the user can perform short distance noncontact wireless communication with a natural posture by using the above-described communication terminal without depending on whether the above-described communication terminal is put on the left or right arm and whether the above-described display portion comes to the inside of the arm or the outside when putting on it.

In addition, it is desirable that the above-described input portion is arranged in a side opposite to the above-described first antenna, that is, in the thumb side (radius side) of the arm in the above-described communication terminal. By arranging in such a manner, since the above-described display direction control portion controls the display direction of the displaying content on the above-described display portion depending on whether the above-described communication terminal is put on the left or right arm (wrist) and whether the above-described communication terminal is put on such that the display portion comes to the inside of the arm or comes to the outside of the arm when putting on, the above-described input portion is always located in the thumb side (radius side) of the arm that the above-described communication terminal is put on. Accordingly, the user can put the above-described communication terminal on either the left and right arm such that the displaying content on the above-described display portion is not vertically and horizontally reversed when viewed from the user and the above-described input portion is always located in the radius side of the wrist of the user. Since the above-described input portion always exists in the thumb side of the wrist of the user, it is easy for the user to operate the above-described input portion with a hand contrary to a hand that the above-described communication terminal is put on. More specifically, when the user tries to perform an action to operate the above-described input portion during when turning the palm downward or bringing the little finger side of the hand close to an external short distance noncontact wireless communication apparatus, for example, the user does not have to do an unnatural action of turning the arm (wrist) upside down, etc. That is, it is possible to operate the above-described input portion by a hand contrary to a hand that the above-described communication terminal is put on without twisting the wrist since the above-described input portion is always located in the thumb side of the wrist even if it is in the midst of performing an action that the user holds the ulna side of the wrist or the palm up over something

A communication terminal (bracelet type communication terminal 2) according to a form 7 of the present invention further comprises an acceleration sensor (18) configured to detect an acceleration of the above-described communication terminal in any one of the above-described forms 1 to 5, and the above-described display direction control portion may control the display direction of the displaying content on the above-described display portion while judging, based on a detection result acquired from the above-described acceleration sensor, whether the above-described communication terminal is put on is a right arm or left arm of the user and whether the display portion exists in an inside or outside of the arm when putting the above-described communication terminal on the arm.

According to the above-described structure, the above-described display direction control portion judges whether the above-described communication terminal is put on the left or right arm and whether the display portion exists in an inside or outside of the arm when putting on the above-described communication terminal based on the detection result concerning a movement of the above-described communication terminal that the above-described acceleration sensor detects. Then, the above-described display direction control portion controls the display direction of the displaying content on the above-described display portion based on the result of the above-described judgement. Therefore, it is unnecessary for the user to notify to the above-described communication terminal, by operating the above-described input portion, selection on whether the above-described terminal is put on the left or right arm and whether the above-described display portion exists in the inside or outside of the arm when putting on the above-described communication terminal, and thus, the convenience improves.

A communication terminal (bracelet type communication terminal 3) according to a form 8 of the present invention further comprises a second antenna (short distance wireless antenna 19) for performing communication with an external setting apparatus (smartphone 5) in any one of the above-described forms 1 to 5, and the above-described display direction control portion may acquire, from the above-described external setting apparatus via the above-described second antenna, information on whether the above-described communication terminal is put on is a right arm or a left arm of a user and whether the above-described display portion exists in the inside or the outside of the arm when putting the above-described communication terminal on the arm, and may control the display direction of the displaying content on the above-described display portion based on the information concerned.

According to the above-described structure, the above-described display direction control portion can acquire, from the above-described external setting apparatus, information concerning the selection on whether the above-described communication terminal is put on the left or right arm and whether the above-described display portion exists in the inside or the outside of the arm when putting the above-described communication terminal on the arm, and controls, based on the information, the display direction of the content displayed on the above-described display portion. Furthermore, since the above-described communication terminal can communicate with the above-described external setting apparatus, it is possible to acquire information that the above-described external setting apparatus holds, including the balance information, for example, and information acquirable via the above-described external setting apparatus, and make the above-described display portion display these pieces of information. In addition, although a short distance wireless antenna, for example can be used for the above-described second antenna, it is not limited to the short distance wireless antenna, and may be an antenna capable of performing the communication with the above-described external setting apparatus.

In a communication terminal (bracelet type communication terminals 1, 2, 3, 4 and 200) according to a form 9 of the present invention, in the above-described form 2 or 3, the control portion (10, 20, 30, 40 and 50) that comprises the above-described display direction control portion and generally controls functions of own terminal may be arranged separately from the above-described antenna (NFC antenna 11).

According to the above-described structure, the above-described communication terminal can make its structure thin in comparison with structure of the conventional communication terminal that the control portion and the antenna are formed into an integral type, and thus, it becomes possible to suppress uncomfortable feeling when the user puts it on the arm.

In a communication terminal according to a form 10 of the present invention, in the above-described form 2 or 3, the above-described antenna is an antenna of a noncontact IC chip that comprises an electronic money settlement function, and on the above-described display portion, information that is related to an electronic money settlement performed between the above-described noncontact IC chip and an external electronic money settlement apparatuses (8) and acquired from the above-described noncontact IC chip or the above-described electronic money settlement apparatus may be displayed.

According to the above-described structure, the information concerning the electronic money settlement that is performed between the above-described noncontact IC chip and the above-described external electronic money settlement apparatus is displayed on the above-described display portion of the above-described communication terminal. Therefore, the user can confirm the information concerning the above-described electronic money settlement (balance of electronic money, amount paid, etc., for example) by only looking at the above-described display portion of the above-described communication terminal that is put on the arm without using any apparatuses (smartphone 5 etc., for example) other than the above-described communication terminal.

In a communication terminal according to a form 11 of the present invention, in the above-described form 2 or 3, the above-described antenna is an antenna of a noncontact IC chip, and identification information of the above-described noncontact IC chip may be displayed on the above-described display portion.

According to the above-described structure, the identification information of the above-described noncontact IC chip is displayed on the above-described display portion of the above-described communication terminal. In particular, in a case where the identification information of the above-described noncontact IC chip (ID of the NFC antenna 11) is stored in the storing portion of the above-described communication terminal in a production process of the above-described communication terminal, the above-described communication terminal can perform the following processing. That is, even in a case where the above-described antenna and the above-described control portion cannot be connected with each other, the above-described communication terminal can display the identification information of the above-described noncontact IC chip on the above-described display portion.

A control method according to a form 12 of the present invention is a control method of a communication terminal comprising a display portion characterized in that the above-described communication terminal is arranged with a first functional portion to be used in a state where a user puts the above-described communication terminal on an arm while being turned toward an opposite side to a user side or arrangeable with the first functional portion concerned, and the method includes a display direction control step configured to control a display direction of a displaying content on the above-described display portion according to whether the above-described communication terminal is put on is a right arm or a left arm of a user and whether the above-described display portion exists in an inside or outside of the arm when putting the above-described communication terminal on the arm.

According to the above-described method, an advantage the same or similar to that of the form 1 can be expected.

A control method according to a form 13 of the present invention is a method of a communication terminal comprising a display portion characterized in the above-described communication terminal being arranged with a second functional portion to be used in a state where a user puts the above-described communication terminal on an arm while being turned toward a user, or arrangeable with the second functional portion concerned, and the method includes a display direction control step configured to control a display direction of a displaying content on the above-described display portion according to whether the above-described communication terminal is put on is a right arm or a left arm of a user and whether the above-described display portion exists in an inside or outside of the arm when putting the above-described communication terminal on the arm.

According to the above-described method, an advantage the same or similar to that of the form 4 can be expected.

### [Rearrangement]

A communication terminal (bracelet type communication terminals 1-4) according to a form 1 of the present invention is a communication terminal comprising the display portion (12) characterized in that a first antenna (NFC antenna 11) for performing short distance noncontact wireless communication in a state where the user puts the above-described communication terminal on an arm is arranged in the ulna side of the arm in a state where the above-described communication terminal is put on the arm, or the first antenna (NFC antenna 61) is arrangeable in the ulna side of the arm, and the above-described communication terminal comprises a display direction control portion (1121) that controls the display direction of the displaying content on the above-described display portion according to whether the above-described communication terminal is put on is a right arm or a left arm of a user and whether the above-described display portion of the above-described communication terminal exists in an inside or outside of the arm when putting the above-described communication terminal on the arm.

According to the above-described structure, in the above-described communication terminal, the user can perform short distance noncontact wireless communication with a natural posture, and it is possible to perform display in a display direction natural for the user without depending on whether putting on the right arm or the left arm and whether the above-described display portion the above-described communication terminal exists in the inside or the outside of the arm when putting on it. That is, the above-described display direction control portion changes the display direction of the displaying content on the above-described display portion such that the above-described first antenna is located in the ulna side of the arm that is attached with the above-described communication terminal without depending on whether the above-described communication terminal is put on is the right arm or the left arm and whether the above-described display portion of the above-described communication terminal exists in the inside or the outside of the arm when putting on it. Therefore, it is possible for the user to perform short distance noncontact wireless communication with a natural posture by using the above-described communication terminal, and the display direction of the content displayed on the above-described display portion always becomes a display direction natural for the user.

In a communication terminal according to the form 2 of the present invention, the above-described display portion may be arranged to be located in the inside of the arm when putting the above-described communication terminal on the arm in the above-described form 1.

According to the above-described structure, by arranging the above-described display portion to be located in the inside of the arm of the user, it becomes difficult for a person except the user to look at the content displayed on the above-described display portion. Especially, in a case where information such as billing information on the electronic money settlement etc. is displayed on the above-described display portion, it is assumed that the user wishes the content displayed on the above-described display portion 12 is not looked at by a person other than the user. In the above-described communication terminal, since the above-described display portion is arranged to be located in the inside of the wrist, it becomes easy for the user to prevent the displaying content such as billing information etc. displayed on the above-described display portion from being looked at by a person other than the user. In addition, information such as a time of day may be displayed on the above-described display portion. Furthermore, in general, if the above-described display portion that displays various kinds of information is located in the inside of the arm (wrist), the user is easy to have a sense of security psychologically. Furthermore, since the above-described display portion is arranged to be located in the inside of the arm (wrist) that the above-described communication terminal is put on, the above-described display portion can have a large area in comparison with a case where it is arranged in the ulna or the radius side of the arm concerned.

A communication terminal according to a form 3 of the present invention further comprises an input portion (17) configured to be selected whether the above-described communication terminal is put on is a right arm or a left arm of the user and whether the above-described display portion exists in an inside or an outside of the arm when putting the above-described communication terminal on the arm in the above-described form 1 or 2, and the above-described display direction control portion may control the display direction of the displaying content on the above-described display portion depending on a selection result that is acquired from the above-described input portion.

According to above-described structure, the above-described display direction control portion acquires a putting-on state of the user, that is, information on whether the above-described communication terminal is put on the left or right arm and whether the above-described communication terminal is put on such that the above-described display portion comes to the inside or the outside of the arm via the above-described input portion. Then, the above-described display direction control portion controls the display direction of the displaying content on the above-described display portion based on the above-described putting-on state. Therefore, by selecting by the above-described input portion whether the above-described communication terminal is put on either the left or right arm and whether the above-described communication terminal is put on such that the above-described display portion comes to the inside or the outside of the arm, the above-described communication terminal can perform display on the above-described display portion in a display direction natural for the user without depending on whether putting on is the left arm or the right arm and whether the above-described display portion comes to the inside of the arm or comes to the outside when putting on it. Furthermore, since the above-described display direction control portion controls the display direction of the displaying content of the above-described display portion based on the putting-on state that is input to the above-described input portion such that the displaying content can be looked at naturally from the user, the user can always put on the above-described communication terminal such that the above-described first antenna is located in the ulna side of the arm. Therefore, the user can perform short distance noncontact wireless communication with a natural posture by using the above-described communication terminal without depending on whether the above-described communication terminal is put on is the left or right arm and whether the above-described display portion comes to the inside of the arm or the outside when putting on it.

In addition, it is desirable that the above-described input portion is arranged in a side opposite to the above-described first antenna, that is, in the thumb side (radius side) of the arm in the above-described communication terminal. By arranging in such a manner, since the above-described display direction control portion controls the display direction of the displaying content on the above-described display portion depending on whether the above-described communication terminal is put on the left or right arm (wrist) and whether the display portion comes to the inside or the outside of the arm when putting on it, the above-described input portion is always located in the thumb side (radius side) of the arm that the above-described communication terminal is put on. Accordingly, the user can put the above-described communication terminal on either the left and right arm such that the displaying content on the above-described display portion is not vertically and horizontally reversed when viewed from the user and the above-described input portion is always located in the radius side of the wrist of the user. Since the above-described input portion always exists in the thumb side of the wrist of the user, it is easy for the user to operate the above-described input portion with a hand contrary to a hand that the above-described communication terminal is put on. More specifically, when the user tries to perform an action to operate the above-described input portion during when turning the palm downward or bringing the little finger side of the hand close to an external short distance noncontact wireless communication apparatus, for example, the user does not have to do an unnatural action of turning the arm (wrist) upside down, etc. That is, it is possible to operate the above-described input portion by a hand contrary to a hand that the above-described communication terminal is put on without twisting the wrist since the above-described input portion is always located in the thumb side of the wrist even if it is in the midst of performing an action that the user holds the ulna side of the wrist or the palm up over something

A communication terminal (bracelet type communication terminal 2) according to a form 4 of the present invention further comprises an acceleration sensor (18) configured to detect an acceleration of the above-described communication terminal in the above-described form 1 or 2, and the above-described display direction control portion may control the display direction of the displaying content on the above-described display portion while judging, based on a detection result acquired from the above-described acceleration sensor, whether the above-described communication terminal is put on is a right arm or left arm of the user and whether the display portion exists in an inside or outside of the arm when putting the above-described communication terminal on the arm.

According to the above-described structure, the above-described display direction control portion judges whether the above-described communication terminal is put on the left or right arm and whether the display portion exists in an inside or outside of the arm when putting on the above-described communication terminal base on the detection result concerning a movement of the above-described communication terminal that the above-described acceleration sensor detects. Then, the above-described display direction control portion controls the display direction of the displaying content on the above-described display portion based on the result of the above-described judgement. Therefore, it is unnecessary for the user to notify to the above-described communication terminal, by operating the above-described input portion, selection on whether the above-described terminal is put on the left or right arm and whether the above-described display portion exists in the inside or outside of the arm when putting on the above-described communication terminal, and thus, the convenience improves.

A communication terminal (bracelet type communication terminal 3) according to a form 5 of the present invention further comprises a second antenna (short distance wireless antenna 19) for performing communication with an external setting apparatus (smartphone 5) in the above-described form 1 or 2, and the above-described display direction control portion may acquire, from the above-described external setting apparatus via the above-described second antenna, information on whether the above-described communication terminal is put on is a right arm or a left arm of a user and whether the above-described display portion exists in the inside or the outside of the arm when putting the above-described communication terminal on the arm, and may control the display direction of the displaying content on the above-described display portion based on the information concerned.

According to the above-described structure, the above-described display direction control portion can acquire, from the above-described external setting apparatus, information concerning the selection on whether the above-described communication terminal is put on the left or right arm and whether the above-described display portion exists in the inside or the outside of the arm when putting on the above-described communication terminal, and controls, based on the information, the display direction of the content displayed on the above-described display portion. Furthermore, since the above-described communication terminal can communicate with the above-described external setting apparatus, it is possible to acquire information that the above-described external setting apparatus holds, including the balance information etc., for example, and information acquirable via the above-described external setting apparatus, and make the above-described display portion display these pieces of information. In addition, although a short distance wireless antenna, for example can be used for the above-described second antenna, it is not limited to the short distance wireless antenna, and may be just an antenna capable of performing the communication with the above-described external setting apparatus.

A control method according to a form 6 of the present invention is a control method of a communication terminal comprising a display portion characterized in that the above-described communication terminal is arranged with a first antenna for performing short distance noncontact wireless communication in a state where the user puts the above-described communication terminal on an arm in the ulna side of the arm in a state where the above-described communication terminal is put on the arm, or arrangeable with the first antenna concerned in the ulna side of the arm, and the method includes a display direction control step (S11-S17) configured to control a display direction of a displaying content on the above-described display portion according to whether the above-described communication terminal is put on is a right arm or a left arm of a user and whether the above-described display portion exists in an inside or outside of the arm when putting the above-described communication terminal on the arm.

According to the above-described method, an advantage the same or similar to that of the form 1 can be expected.

In addition, the above-described communication terminal may be implemented by a computer, and in such a case, a control program of a communication terminal implements the above-described communication terminal by operating the computer as the above-described display direction control portion, and a computer readable recording medium that is stored with it enter under a scope of the present invention.

The present invention is not limited to respective embodying forms described above, and various changes is possible within the range shown in the claims, and any embodying forms obtained by suitably combining the technical means respectively disclosed in the different embodying forms are also included within the technical scope of the present invention. Furthermore, it is possible to form a new technical feature by combining the technical means disclosed by each of the embodying forms, respectively.

### INDUSTRIAL AVAILABILITY

The present invention can be widely applied to a communication terminal that the user puts it on an arm and comprises a display portion.

### DESCRIPTION OF NUMERALS

1—a bracelet type communication terminal (communication terminal)
2—a bracelet type communication terminal (communication terminal)
3—a bracelet type communication terminal (communication terminal)
4—a bracelet type communication terminal (communication terminal)
5—a smartphone (external setting apparatus)
8—an electronic money settlement apparatus
10—a control portion
11—an NFC antenna (antenna for performing short distance noncontact wireless communication)
12—a display portion
17—an input portion
18—an acceleration sensor
19—a short distance wireless antenna (second antenna)
20—a control portion
30—a control portion
40—a control portion
50—a control portion
61—an NFC antenna (antenna for performing short distance noncontact wireless communication)
101—an input receiving portion (user input receiving portion)
102—a camera (imaging portion)
103—a light (light emitting portion)
104—an infrared sensor (light receiving portion)
105—a microphone (user input receiving portion)
106—an LED (light emitting notification portion)
120—a first functional portion
130—a second functional portion
200—a bracelet type communication terminal (communication terminal)
1121—a display direction control portion

1: A communication terminal comprising a display portion characterized in that
a first functional portion to be used in a state where a user puts the communication terminal on an arm while being turned toward an opposite side to a user side is arranged or the first functional portion concerned is arrangeable, and
the communication terminal comprises a display direction control portion configured to control a display direction of a displaying content on the display portion according to whether the communication terminal is put on is a right arm or a left arm of the user and whether the display portion exists in an inside or an outside of the arm when putting the communication terminal on the arm.

2: The communication terminal according to the claim 1 characterized in that the first functional portion is at least any one of an antenna for performing short distance noncontact wireless communication, an imaging portion, a light emitting portion and a light receiving portion.

3: The communication terminal according to the claim 1 characterized in that the first functional portion includes (i) an antenna for performing short distance noncontact wireless communication and (ii) at least one of an imaging portion, a light emitting portion and a light receiving portion.

4: A communication terminal comprising a display portion characterized in that
a second functional portion to be used in a state where a user puts the communication terminal on an arm while being turned toward the user is arranged or the second functional portion concerned is arrangeable, and
the communication terminal comprises a display direction control portion configured to control a display direction of a displaying content on the display portion according to whether the communication terminal is put on is a right arm or a left arm of the user and whether the display portion exists in an inside or an outside of the arm when putting the communication terminal on the arm.

5: The communication terminal according to the claim 4 characterized in that the second functional portion is at least any one of a user input receiving portion, a light emitting notification portion, a speaker portion and a measurement sensor portion.

6: The communication terminal according to claim 1 characterized in that the communication terminal further comprises an input portion configured to be selected to whether the communication terminal is put on is a right arm or a left arm of the user and whether the display portion exists in an inside or an outside of the arm when putting the communication terminal on the arm, and
the display direction control portion controls the display direction of the displaying content on the display portion depending on a selection result that is acquired from the input portion.

7: The communication terminal according to claim 1 characterized in that the communication terminal further comprises an acceleration sensor configured to detect an acceleration of the communication terminal, and
the display direction control portion controls the display direction of the displaying content on the display portion while judging, based on a detection result acquired from the acceleration sensor, whether the communication terminal is put on is a right arm or a left arm of the user and whether the display portion exists in an inside or an outside of the arm when putting the communication terminal on the arm.

8: The communication terminal according to claim 1 characterized in that the communication terminal further comprises a second antenna for performing communication with an external setting apparatus, and
the display direction control portion acquires, from the external setting apparatus via the second antenna, information about whether the communication terminal is put on is a right arm or a left arm of the user and whether the display portion exists in an inside or an outside of the arm when putting the communication terminal on the arm, and controls the display direction of the displaying content on the display portion based on the information concerned.

9: The communication terminal according to the claim 2 characterized in that a control portion that comprises the display direction control portion and generally controls functions of own terminal is arranged separately from the antenna.

10: The communication terminal according to the claim 2 characterized in that the antenna is an antenna of a noncontact IC chip that comprises an electronic money settlement function, and
information that is related to an electronic money settlement performed between the noncontact IC chip and an external electronic money settlement apparatuses and acquired from the noncontact IC chip or the electronic money settlement apparatus is displayed on the display portion.

11: The communication terminal according to the claim 2 characterized in that the antenna is an antenna of a noncontact IC chip, and identification information of the noncontact IC chip is displayed on the display portion.

12: A control method of a communication terminal comprising a display portion characterized in that
the communication terminal is arranged with a first functional portion to be used in a state where a user puts the communication terminal on an arm while being turned toward an opposite side to a user side or arrangeable with the first functional portion concerned, and
the method includes a display direction control step configured to control a display direction of a displaying content on the display portion according to whether the communication terminal is put on is a right arm or a left arm of a user and whether the display portion exists in an inside or outside of the arm when putting the communication terminal on the arm.

13: A control method of a communication terminal comprising a display portion characterized in that
the communication terminal is arranged with a second functional portion to be used in a state where a user puts the communication terminal on an arm while being turned toward a user, or arrangeable with the second functional portion concerned, and
the method includes a display direction control step configured to control a display direction of a displaying content on the display portion according to whether the communication terminal is put on is a right arm or a left arm of a user and whether the display portion exists in an inside or outside of the arm when putting the communication terminal on the arm.

14: A non-transitory computer-readable medium including a control program for making a computer function as the communication terminal according to claim 1, and the control program makes the computer function as the display direction control portion.
